(19) United States
(12) Patent Application Publication
(10) Pub. No.: US 2006/0173787 A1
(43) Pub. Date: Aug. 3, 2006

(54) Data protection management apparatus and data protection management method

(76) Inventors: Daniel Weber, OSAKA (JP); Stefan Walter, Adliswil (CH); Kenichi Kubota, Yokohama-shi (JP)

Correspondence Address: WENDEROTH, LIND & PONACK L.L.P., 2033 K. STREET, NW, SUITE 800, WASHINGTON, DC, 20006, US

(21) Appl. No.: 10/549,450

(22) PCT Filed: Mar. 23, 2004
(86) PCT No.: PCT/JP04/03945

§ 371 Date: Sep. 14, 2005

(30) Foreign Application Priority Data
Mar. 24, 2003 (JP) 2003-080266

(51) Int. Cl. G06Q 99/00

(52) U.S. Cl. 705/59

(57) ABSTRACT

The data protection management apparatus protects digital licenses and digital data, so that the abuse and illegal use of digital data is prevented. The apparatus has an I/O port, session manager, license management engine, usage rules administrator, encryption engine, memory manager, and memory. The license management engine acquires, stores, and manages licenses in sessions opened by the session manager, and the usage rules administrator provides an encryption algorithm and protocol for securely storing and sending digital license data by applying the usage rules to the use of licenses managed by the license management engine.

### TECHNICAL FIELD

The present invention relates to an apparatus and a method for protecting digital data, and relates more particularly to protecting distributed data, license data, and electronic tickets when distributing data using a license.

### BACKGROUND ART

Digital content distribution services whereby users can download and play digital content from a content provider over a network have been growing. Content providers providing these services allow the use of their digital content when it can be determined that their intellectual property will not be subject to copyright infringement or illegal reproduction or use.

One method for providing digital content security protects against the illegal use of digital content by using a dedicated secret algorithm for each user in combination with a user identifier (see, for example, patent reference 1). This makes it possible to limit digital content reproduction to only a dedicated device or compatible PC hardware having a unique ID (device-dependent), and this can protect data from illegal copying.

FIG. 18 is a schematic diagram of a conventional data distribution system. This system includes a content provider server 100 (called a server below), a personal computer (PC) 104, and a client 106. The server 100 and PC 104 are connected over a network, and the client 106 is a device for storing and processing, including playing, the content distributed from the server 100 over the network When content is acquired from the content storage device 102 of the server 100, the server 100 uses a serial number (or device number) reported from the client 106 as an encryption key 101 to encrypt the content for distribution (103). It is not necessary to use the serial number itself as the encryption key, and the serial number could be used to generate a key or password needed for encryption. The encrypted content is sent through the PC 104 to the client 106. When the PC 104 receives encrypted content, the PC 104 could notify the client 106 at a desired time instead of notifying the client 106 immediately. The content could also be archived on the PC 104. The distributed encrypted content could therefore be stored in an encrypted content storage device 105 of the PC 104. The client 106 then decrypts and processes (107) the received encrypted content using the included decryption key 109, and stores the decrypted content in a content storage device 108. The decrypted content could also be played on-the-fly without being stored in content storage device 108.

Content can thus be distributed by, as described above, the client sending a serial number to the server, and the server then sending to the client content data that the server encrypted based on the received serial number.

FIG. 19 is also a schematic diagram of a conventional data distribution system. This system also includes a content provider server 201 (called a server below), a PC 205, and a client 211. To distribute content stored in the content storage device 202 of the server 201, the server 201 generates a key related to the content, the user, or the client 211 (203), and encrypts the content using this key (204). When the PC 205 sends a content request to the server 201, it receives the encrypted content and the related key from the server 201, and stores the content to a content storage device 206 and the key to a key storage device 207. Before sending the content stored in the content storage device 206 to the client 211, the PC 205 decrypts the content using the correlated key stored in the key storage device 207 (208), and re-encodes the content using a key 210 acquired from the client 211 or from the session reporting to the client 211 (209). The client 211 stores the received encrypted content to content storage device 212. Before the content is played or other media output process is run, the content is decrypted using the session key stored in session key storage device 214 (215). The received encrypted content could first be decrypted and then stored in content storage device 212.

Content can thus be distributed by sending content encrypted using a server-generated key and the key to the PC, and then re-encrypting the content using a different key (session key) between the PC and client.

A related invention is disclosed in Japanese Patent Application Publication No. H7-295800

### DISCLOSURE OF INVENTION

(Technical problem to be solved by the invention) In order to protect data from illegal Copying using the prior art technology described above, however, it is only possible to play content that has been downloaded to a dedicated playback device or compatible PC hardware having a unique, device-dependent ID. This could mean that when the user updates the operating system (OS) or hardware, it may no longer be possible to play content that was playable before the update. Furthermore, if a dedicated playback device is needed for content playback, users are unable to enjoy content data anywhere and anytime they would like.

In addition, because content can only be played using a dedicated playback device, content stored to memory cards, IC cards, SD cards, CD-R discs, and other removable storage media cannot be played using a different playback device.

Furthermore, users that do not have a network connected to a PC are unable with the existing systems to use content available from content providers.

The present invention is directed to solving these problems of the prior art, and an object of the invention is to prevent the illegal use and abuse of digital content, provide users with freedom of choice for selecting a playback device, and strengthen the protection of digital content when digital content is used. A further object of the invention enable data distribution via a variety of distribution channels so that the content distribution means does not depend only on networks.

(Means for Solving the Problem)

To solve the problem described above, a data protection management system according to the present invention is a data protection management system enabling data communication of a license and encrypted content between a sender and a receiver while protecting and managing the communicated data, comprising: a session manager for executing a process for acquiring a license and encrypted content from a sender; a license management engine for storing and managing the license acquired by the session manager; and memory for storing the license. When a challenge, which is provided as part of a request for proof of a license, is received, the session manager generates a certificate verifying the license and sends the generated certificate to the receiver.

A data protection management system according to the present invention is further comprising a usage rules administrator for determining usage rules related to the license, and applying the usage rules to processing at least one of the license and content.

In a data protection management system according to the present invention, the session manager encrypts the certificate.

In a data protection management system according to the present invention the session manager adds an optional item from the license to the certificate.

A data protection management system according to the present invention wherein the optional item data is encrypted using a key contained in the license.

In a data protection management system according to the present invention, the usage rules include information for determining, based on the license, data to be added to the certificate.

In a data protection management system according to the present invention, the session manager, when a license change is received from the sender, reads the license before the change from the license management engine, changes the license, and saves the changed license using the license management engine.

In a data protection management system according to the present invention, the session manager uses the key associated with the license to decrypt content.

In a data protection management system according to the present invention, the session manager re-encrypts the decrypted content.

A data protection management system according to the present invention is characterized by generating the key used for re-encryption based on information from the sender.

A data protection management system according to the present invention is characterized by having a session manager unit for running a process to manage connections, exchange trust certificates for mutual authentication with a connected party, and applying access limits on licenses and data following thereafter on the opened connection; a license management engine unit for acquiring a license in the session opened by the session manager unit, and storing and managing acquired licenses; a usage rules administration unit for determining the usage rules related to the licenses managed by the license management engine unit, and applying the usage rules to processing the licenses and data; an encryption engine unit having a public key or shared key encryption algorithm and hash algorithm required to encrypt, decrypt, and sign data, and providing an encryption protocol function for the open session; a memory management unit for controlling memory access and providing space for encryption and decryption by the encryption engine unit; and memory for storing the data, license, and connection conditions. This data protection management system is below referred to as a “secure container.”

Safe management of license data can thus be assured by providing an encryption algorithm and protocol for securely saving, receiving and sending digital license data.

A data protection management system according to the present invention is further characterized by holding at least one encryption/decryption key unique to the system. A key unique to the system can therefore be use for content encryption, and data theft and tampering can prevented more safely and securely.

A data protection management system according to the present invention is further characterized by a log management engine for storing information relating to rule changes based on the data distribution process, and controlling reading and writing this log information. This enables the secure container to record transactions and perform other security related operations, and enables the system manufacturer or trusted third party to recognize if the secure container or digital license data stored therein has been tampered with or abused.

A data protection management method according to the present invention is characterized by a step for storing data encrypted by a sender using a key related to data for distribution; a step for sending the encrypted data from the sender to a data processing device; a step for sending a command set containing one or more control commands from the sender to the data processing device; a step for opening a secure data channel between the data processing device and a receiver; a step for sending a command set containing one or more control commands from the sender to the data processing device; and a step for the data processing device to decrypt the encrypted data using the key based on the command set, and send the decrypted data to the receiver over the secure data channel.

This command set is also referred to as usage rules. In addition, the sender is also called a “source” and the receiver is also called a “sink.” This data processing device is also the secure container referred to above. It is therefore possible by sending data through a secure container to safely send data from a source to a sink while applying necessary operations and control.

The data protection management method of this invention is characterized by including in the command set a control command specifying the encryption strength used on the secure data channel. This enables managing the encryption strength (that is, the strength of the secure channel between the secure container and sink) with a control command, and to flexibly improve data safety according to the type of data channel.

The data protection management method of this invention is further characterized by including in the command set a control command for declaring the period for which the secure data channel is valid. This enables a control command for managing encryption (a secure channel between the secure container and sink) to define the period in which re-encryption is possible, and makes it possible to construct a purchasing system enabling customers to copy and save broadcast data, for example, for personal use for a certain purchasing period, or for the planned use of data.

The data protection management method of this invention is further characterized by including in the command set a control command indicating how many copies of the data are sent to the sink. The command set for managing encryption (a secure channel between the secure container and sink) can therefore be used for data backups and sharing by specifying how many times copies can be sent to the sink. Because the content is linked to a particular customer, monitoring and auditing are also possible.

The data protection management method of this invention is further characterized by including a control command sent from the sender to the data processing device in the command set. This enables adding a control command set sent from the source to the secure container, and has the advantage of enabling the source to specify the security conditions. The default conditions defined in the command set attached to the license or key are never weakened, however.

The data protection management method of this invention is further characterized by including a control command sent from the receiver to the data processing device in the command set. This enables adding a control command set sent from the sink to the secure container, and has the advantage of the sink being able to specify the security conditions. The default conditions defined in the command set attached to the license or key are never weakened, however.

The data protection management method of this invention is further characterized by including a control command indicating the conditions to be applied by the sink in the command set. This enables a control command for managing encryption (a secure channel between the secure container and sink) to define rules for the sink, and as a result enables the source to specify rules for the sink. The source could, for example, specify that the sink must conform to a certain security standard, such as requiring user confirmation for high cost data, in order to complete a purchase.

A further data protection management method according to the present invention is characterized by a step in which a sender encrypts data using a key related to the data for distribution; a step for sending the encrypted data from the sender to a data processing device; a step for sending the key used for encryption from the sender to the data processing device; a step for sending a command set containing one or more control commands from the sender to the data processing device; and a step wherein the data processing device decrypts the encrypted data using the key based on the command set, and then re-encrypts the data using a key related to the receiver.

As a result, data correlated to the sink can be individualized in the re-encryption process so that after the data is encrypted, it can only be decrypted by the corresponding sink, thereby further improving data safety.

This data protection management method of the present invention is characterized by including in the command set a control command specifying the calculation time allowed for re-encryption. This affords constructing a commerce system that allows a customer to copy and save broadcast data, for example, for personal use for a specified purchasing period.

This data protection management method of the present invention is characterized by including in the command set a control command specifying how many re-encrypted copies of the data can be generated. This enables the control command for managing re-encryption to specify the number of allowed copies. This is useful for data backup and sharing, and because the content is linked to a unique customer, enables monitoring and auditing.

This data protection management method of the present invention is characterized by including in the command set a control command denoting the conditions that must be applied by the receiver. This enables the control commands for managing re-encryption to define specific conditions for the sink, and as a result the source can define conditions to be applied by the sink. The source could, for example, specify that the sink must conform to a specific security standard in order to purchase certain high cost data.

This data protection management method of the present invention is characterized by including in the command set control commands sent from the receiver to the data processing device. This enables the control commands managing the re-encryption process to reside in the sink, affording the advantage of the sink being able to independently run the re-encryption process. Furthermore, if the control commands reside in the source and re-encryption is completed on the source, a source corresponding to the data creator or owner can completely control the re-encryption process. Because content can be individualized to the customer with the present invention, the content cannot be used by another person. The content can also be encrypted to not to be individualized by the re-encryption process.

A further data protection management method according to the present invention is characterized by a step for mutual authentication by the sender and data processing device; a step for opening a secure data channel between the sender and data processing device; a step for sending from the source to the data processing device a challenge requesting proof of ownership of a specific license; a step wherein the data processing device generates unique proof based on a command set using the challenge and the specific license; a step wherein the data processing device sends the generated proof to the sender; and a step wherein the sender verifies the received proof.

It is therefore possible to prove that a specific license resides in the sink without providing detailed license information to the source. In other words, to get proof that a license is stored in the license pool of the sink, the source uses a secure channel to request the sink to issue a certificate of proof. The sink (secure container) generates the certificate with reference to the request (challenge) sent from the source to the sink. The generated certificate is then sent over the secure channel to the source. The advantage of issuing a certificate unique to the license is that the sink does not need to send detailed license information to the source. Furthermore, this certificate can also be used in an electronic ticket system that in which this license is used in place of an electronic ticket. Moreover, by using the command set from the source, the license issuer can control the method whereby the certificate is generated.

This data protection management method of the present invention is characterized by the data processing device encrypting the challenge and proof using the public key of the sender when generating the certificate. This enables encrypting the proof using a public key encryption method, and it is therefore not necessary for the connection between the source and secure container to be secure. Security is achieved by the public key encryption method in this case. The public key of the source can be embedded in the license in this case.

A data protection management method of the present invention is further characterized by the data processing device encrypting generated proof using the key embedded in the license when generating the proof. Part of the license can therefore be used as the key, and only the license issuer or a trusted third party can decrypt the proof. Furthermore, if the source can decrypt the certificate, the source can be considered a trusted party, and the source therefore does not need to verify itself to the secure container.

A data protection management method of the present invention is further characterized by sending proof together with additional data contained in the license to the sender when sending the generated proof to the sender. This enables sending the proof to the source after adding additional data from the license to the proof. This method thereby affords an electronic ticket.

A data protection management method of the present invention is further characterized by encrypting the additional data using a key contained in the license. This enables adding additional data from the license to the proof, and encrypting either the proof or the additional data, or both, before transmission to the source. An electronic ticket can therefore be achieved by this method.

A data protection management method of the present invention is further characterized by including in the command set information data for determining, based on the license, what data should be added to the certificate. This makes it possible to include information indicating what data from the license should be added to the certificate in the control command for managing proof generation. As a result, a specific subset of data attached to the license can be added to the proof.

A data protection management method according to the present invention is a method for changing conditional information of a specific license stored in the data processing device, and is characterized by a step for mutual authentication by the sender and data processing device; a step for opening a secure data channel between the sender and data processing device; a step for sending from the sender to the data processing device a request to change the conditional information of a specific license together with a challenge requesting proof that the license is resident; a step wherein the data processing device changes the conditional information of the specific license according to the request; a step wherein the data processing device generates unique proof based on the command set using the challenge and the specific license; a step wherein the data processing device sends the generated proof to the sender; a step wherein the sender verifies the received proof.

Conditional information relating to the license can, as necessary, thus be allocated to the license or embedded in the license. That is, to change the license rules, mutual authentication between the source and secure container is first attempted, and if authentication succeeds, a secure channel is opened. Next, a request to change the license conditions is sent from the source to the secure container, and the secure container operates according to the request. If changing the license conditions succeeds, the secure container sends proof to the source. The source then confirms the result of the requested change from the received proof. The advantage of this method is that two-way or multiple electronic tickets can be achieved by changing the license condition information, and the use of digital data corresponding to the license can be limited.

A data protection management method according to the present invention is a method for storing a specific license in a data processing device, and is characterized by a step for mutual authentication between a sender and a data processing device; a step for opening a secure data channel between a sender and the data processing device; a step for sending the specific license from the sender Lo the data processing device; and a step whereby the data processing device, based on a command set, stores the specific license received.

That is, the secure container and source attempt mutual authentication, and if authentication succeeds, a secure channel is opened between the secure container and source. The received license data is stored in internal memory in the secure container. As a result, when storing a license in a secure container, license data can be sent securely from the source to a device and can be stored safely in memory in the device. The license data is never revealed as plain text.

A data protection management method according to the present invention is a method for storing a specific license in a data processing device, and is characterized by a step for mutual authentication between a sender and a data processing device; a step for sending a public key related to the receiver from the data processing device to the source; a step wherein the source encrypts the specific license using the received public key, and sends the encrypted license to the data processing device; and a step wherein the data processing device decrypts the encrypted license using a secret key correlated to the receiver.

That is, the secure container and source attempt mutual authentication, and if authentication succeeds, a public key assigned to the device is sent to the source. The source then encrypts the license data using the received public key, and sends the encrypted data to the secure container. The secure container then stores the received data in internal memory. As a result, when storing a license in a secure container, the license data is sent securely from the source to the device, and stored safely in the device memory. The license data is never revealed as plain text.

### BRIEF DESCRIPTION OF DRAWINGS

FIG. 1 is a block diagram showing an example of the configuration of a secure container in a first embodiment of the present invention.

FIG. 2 is a block diagram showing an example of the configuration of a secure container in a second embodiment of the present invention.

FIG. 3A shows a procedure for passing decrypted content to a sink.

FIG. 3B outlines the transcoding process of a secure container in a first embodiment of the present invention.

FIG. 4 is a flow chart of an example of a transcoding process for a secure container according to a first embodiment of the present invention.

FIG. 5 is a flow chart of an example of a transcoding process for a secure container according to a first embodiment of the present invention.

FIG. 6A shows a procedure for passing decrypted content to a secure container.

FIG. 6B shows a re-encryption process for a secure container according to a first embodiment of the present invention.

FIG. 7 is a flow chart showing an example of a re-encryption process for a secure container according to a first embodiment of the present invention.

FIG. 8 is a flow chart showing an example of a periodic re-encryption process for a secure container according to a first embodiment of the present invention.

FIG. 9A shows a procedure whereby the source receives proof of a license.

FIG. 9B shows a process for generating proof of a license for a secure container according to a first embodiment of the present invention.

FIG. 10 is a flow chart of an example of a process for generating proof of a license for a secure container according to a first embodiment of the present invention.

FIG. 11A shows a procedure whereby a source receives a verification of license change.

FIG. 11B shows a process for generating proof of a license, and then changing the license, for a secure container according to a first embodiment of the present invention.

FIG. 12 is a flow chart of an example of a process for generating proof of a license, and then changing the license, for a secure container according to a first embodiment of the present invention.

FIG. 13A shows a procedure for storing a license.

FIG. 13B shows a process for storing a license for a secure container according to a second embodiment of the present invention.

FIG. 14 is a flow chart of an example of a process for storing a license for a secure container according to a second embodiment of the present invention.

FIG. 15 is a schematic diagram of a data distribution system according to a first embodiment of the present invention.

FIG. 16 is a schematic diagram of another example of a data distribution system according to a first embodiment of the present invention.

FIG. 17 is a schematic diagram of the network environment of a data distribution system according to a first embodiment of the present invention.

FIG. 18 is a schematic diagram of a data distribution system according to the prior art.

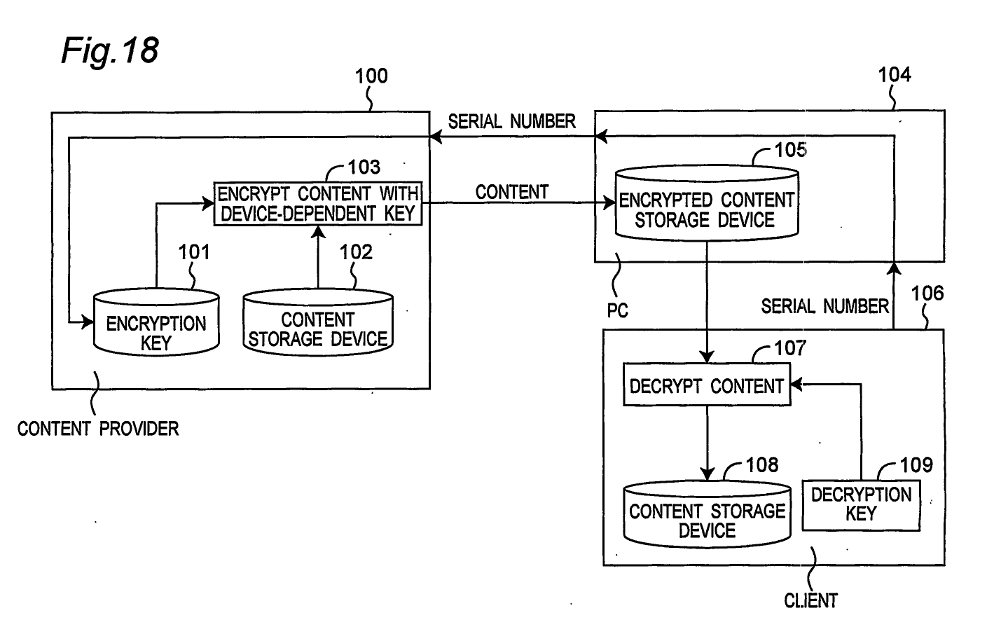

FIG. 19 is a schematic diagram of another data distribution system according to the prior art.

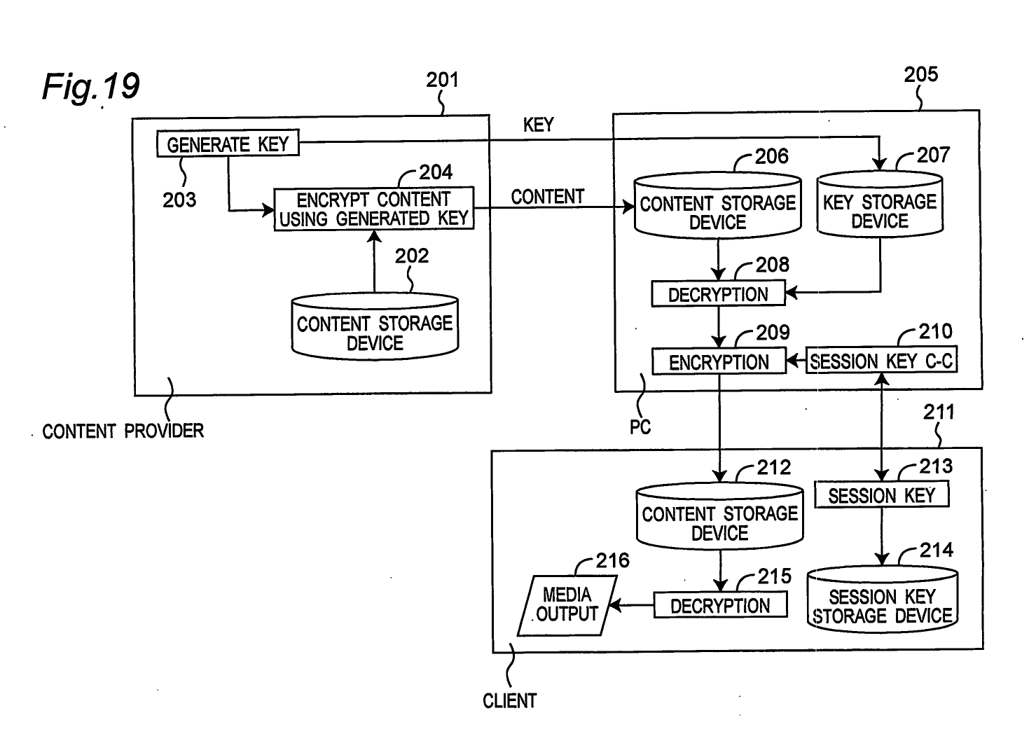

### BEST MODE FOR CARRYING OUT THE INVENTION

Preferred embodiments of the present invention are described below with reference to the accompanying figures.

### First Embodiment

The ability to limit the illegal use of content and protect he data is needed in a data distribution system that uses a network to acquire content data stored on a server such as operated by a content provider. A data protection management apparatus according to a first embodiment of the present invention is a DRM (digital rights management) system in a secure container such as an IC card or other tamper-resistant hardware, and provides normal digital license management and digital data storage control related to digital licenses and other licenses. Note that these could be hardware or software constructions.

Licenses often contain related usage rules. Usage rules define the license and the rules relating to the use of digital data related to the license. Predefined default settings are applied if rules relating to a specific process are not defined by usage rules. If the default settings and the usage rules differ, more secure rules with stronger restrictions must be applied.

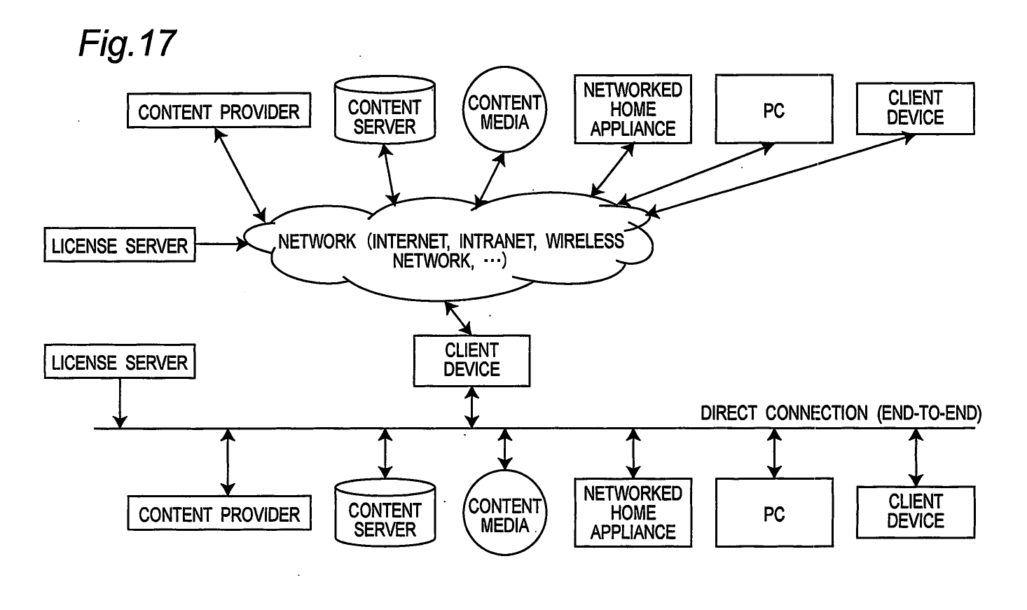

FIG. 17 is a schematic diagram showing the network environment of a data distribution system. A DRM system according to a first embodiment of this invention is incorporated in a client device that downloads digital data over a network from a content provider or content server. The network could be a wired or wireless network, the Internet or an intranet, a 1:1 direct connection to the server, a connection to both the Internet and a local LAN, or other configuration.

A DRM system according to this first embodiment of the invention is described in detail next.

A DRM system assures safe license data management by providing an encryption algorithm and protocol for securely storing and transmitting license data. It can also be applied to digital data that is sent through a card used as an additional data security layer between the data sender (source) and the receiver (sink).

A device comprising this DRM system and securely managing licenses and digital data is referred to below as a “secure container.” This secure container is a secure, tamper-resistant device. License data (or content data) acquired from a source is stored in memory in this secure container.

A “source” refers to any source from which content data is acquired, and denotes both the content provider and content server. A “source” also includes content media, such as CD-ROM and DVD.

A “sink” is any receiver acquiring content data from a source, and denotes devices such as the client device and playback device. The sink could have recordable media such as a memory card, IC card, SD (Secure Digital) card, or CD-R disc, and have a function for reading and writing to recordable media. Playing the content data is also possible on a separate read-only device by loading the recording medium in the playback device.

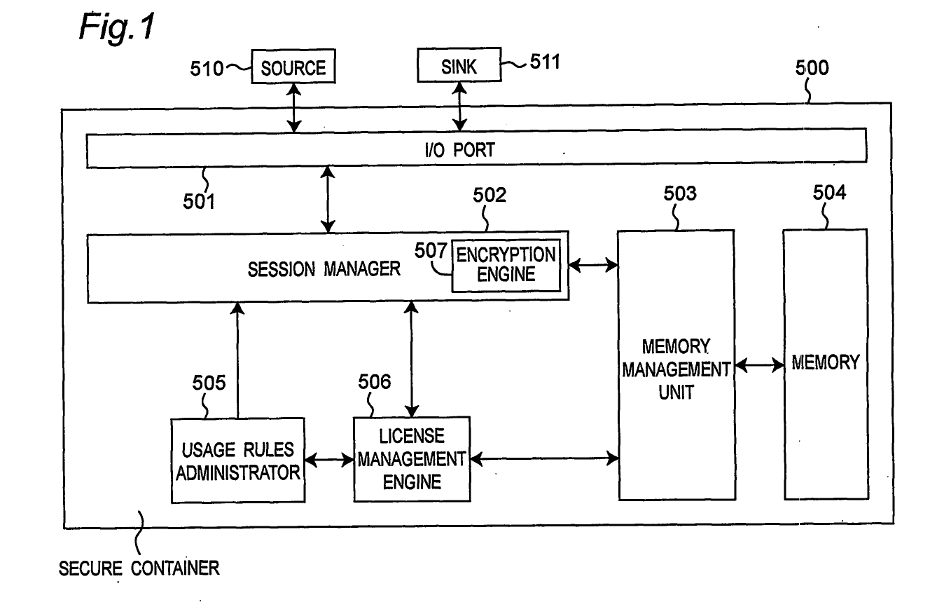

FIG. 1 is a function block diagram showing the configuration of a secure container according to this first embodiment of the invention.

The secure container 500 has an I/O port 501, session manager 502, license management engine 506, usage rules administrator 505 (the usage rules are also referred to as a command set), encryption engine 507, memory management unit 503, and memory 504. Connected to the I/O port 501 are source 510 from which content is transmitted, and sink 511 to which the content is sent. The sink 511 includes one or all of such devices as a recorder, a playback device, display, audio output device, and printer. The sink 511 may also contain a secure container 500.

The session manager 502 manages connections through the I/O port 501. Connections as used here are not limited to normal connections, and include secure connections using the encryption engine 507. The session manager 502 starts a session by exchanging and mutually verifying certificates with the connecting party, and can then manage restricted access, such as allowing access to license data and the related content data.

The license management engine 506 acquires license data through the I/O port 501 in the session opened by the session manager 502, and stores the same in memory 504 and manages the acquired license data.

The usage rules administrator 505 determines the usage rules related to the license data that is managed by the license management engine 506 and processed by the usage rules administrator 505, and applies the usage rules to processing the license data and content data. These usage rules could contain various rules including the copy limit controlling how many times the content can be copied, and partial decoding permissions.

The encryption engine 507 contains encryption algorithm and hash algorithm for the public key or shared key needed to sign, encrypt, and decrypt the content data, and provides an encryption protocol function for the session opened by the session manager 502.

The memory management unit 503 controls access to memory 504, and provide working area for encryption and decryption by the encryption engine 507. The memory 504 stores content data, license data, and connection state information.

Thus comprised, a secure container can provide an encryption algorithm and protocol for securely storing and sending digital license data, and can thereby ensure that safe license data management.

All required operations are also executed inside the secure container so ensure that the digital license cannot leave the secure container in a plain text format.

All or part of this secure container can be constructed in software, and a secure container can be provided in devices such as cell phones. Furthermore, it is also basically possible to manufacture a memory card type device for digital license and data management by embedding this secure container in a memory card type storage device, thereby rendering a secure container in a SD card or other type of memory card device. It is also possible to manufacture a memory card type device for digital license and data management by adding new functionality to a conventional data storage device.

Furthermore, digital license data could be stored in a standardized file format rather than in a proprietary format in memory by building an ISO/IEC 9293 compliant FAT file system into the memory of a secure container according to this first embodiment of the invention, and a public API for digital license data administration tasks including storing and searching digital license data, can be provided.

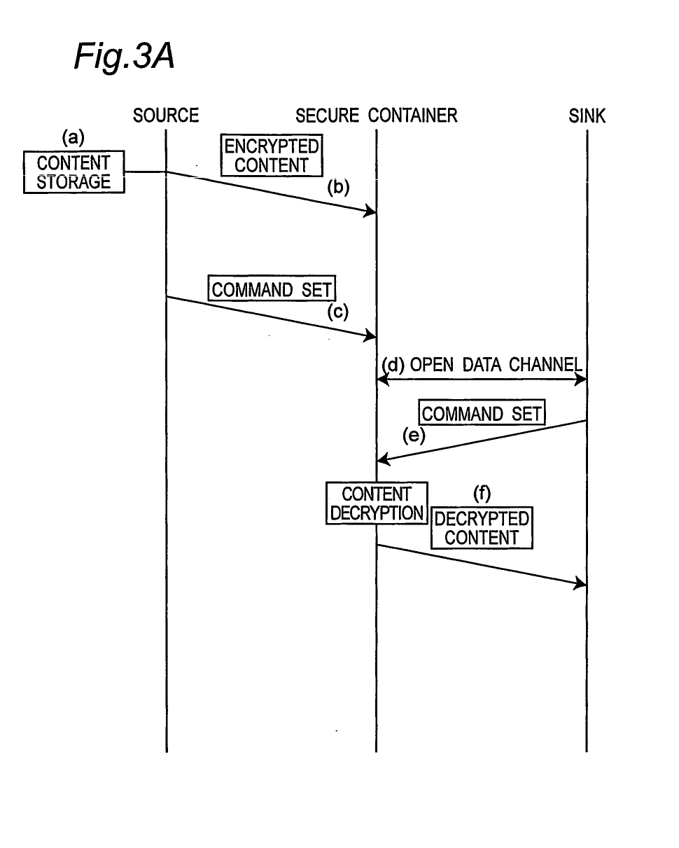

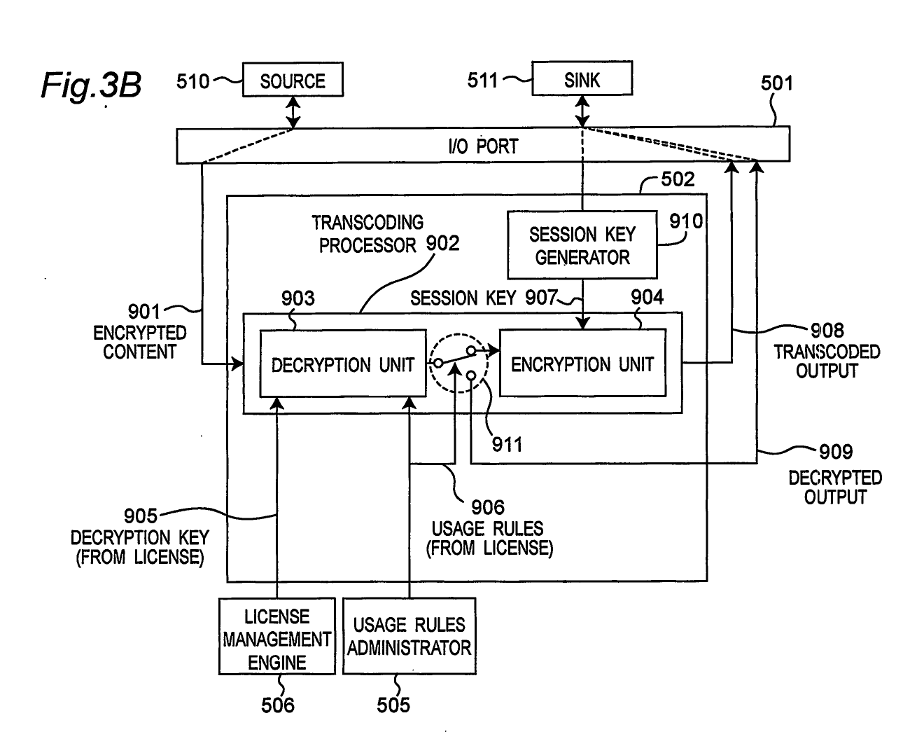

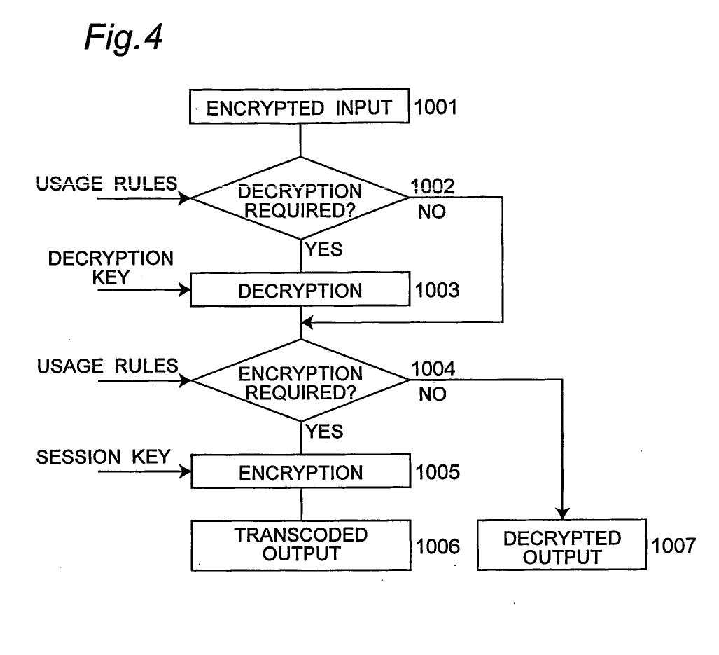

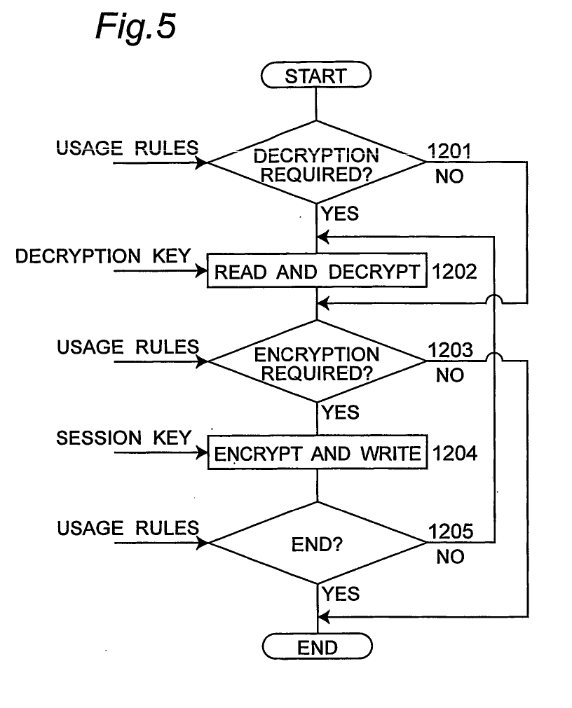

A method for sending digital data (content) from a particular source to a particular sink through a secure container according to this first embodiment of the invention is described next with reference to FIG. 3A, FIG. 3B, FIG. 4, and FIG. 5.

Four data sets are defined in the transcoding process when sending content from a source to a sink through the secure container 500. These four data sets are the content 901 (which is encrypted by a corresponding key), the key (which is part of the license) for encrypting the content, a session key used on the secure channel between the secure container 500 and sink, and a command set (which is part of the license) corresponding to a particular key and used for internal control operations of the secure container 500. These command sets are sent from the source or sink to the secure container 500, but the timing at which they are sent and the communication means do not need to be the same, and can be sent on different buses.

As shown in FIG. 3A, the source to sink transmission process is broken down into the six steps described below. That is, (a) the source stores the content 901 encrypted by a key related directly or indirectly to the content, (b) sending the encrypted content from the source to the secure container, (c) sending the command set from the source to the secure container, (d) opening a secure data channel between the secure container and sink, (e) sending the command set from the sink to the secure container, and (f) decrypting the content 901 using the associated key, transcoding the data, and then transferring the data over the secure data channel.

FIG. 3B describes the transcoding process in the above step (f) in a secure container according to this first embodiment of the invention.

Encrypted content 901 sent from the source 510 is input to the session manager 502 through I/O port 501. The session manager 502 has a transcoding processor 902 composed of decryption unit 903 and encryption unit 904, and a session key generator 910. Decryption key 905 from the license management engine 506 and usage rules 906 from the usage rules administrator 505 are input to the decryption unit 903. The encrypted content 901 is decrypted by the decryption unit 903 using the decryption key 905. The decrypted content is output as conditioned content to which specific restrictions, such as the number of times the content can be played or the part that can be played, have been applied. Depending on the usage rules, the decrypted output is sent from the I/O port 501 to the sink 511, or to the encryption unit 904, or not outputted at all.

Using the session key 907, the encryption unit 904 re-encrypts the content, and outputs the result from the I/O port 501 to the sink 511 as transcoded output 908. In this embodiment of the invention the session key 907 is generated by the session key generator 910 based on information from the sink 511. The sink 511 decrypts the re-encrypted content so that the content is playable. The content is re-encrypted by the encryption unit 904 to improve content protection. The transcoding processor 902 thus changes the coding format of the content. The session key generator 910 can also be configured to generate a challenge (token) based on information from the sink 511.

FIG. 4 is a flow chart showing an example of the transcoding process of a secure container according to this first embodiment of the invention.

First, the session manager 502 receives encrypted content from the source through the I/O port 501 (1001).

The license management engine 506 gets the license data linked to the received content from the memory 504, and reports the acquired license data to the usage rules administrator 505. Based on this license data, the usage rules administrator 505 then determines the usage rules, and applies the usage rules to determine whether decryption is needed (1002).

If decryption is needed (1002 returns yes), the encryption engine 507 decrypts the encrypted content using the decryption key based on the license data (1003). If decryption is not needed (1002 returns no), control proceeds from step 1004 without decryption.

The usage rules administrator 505 then applies the previously determined usage rules to determine whether encryption is needed (1004).

If encryption is needed (1004 returns yes), the encryption engine 507 encrypts the content using the session key (1005), and the session manager 502 then outputs the transcoded content (the re-encrypted content) through the I/O port 501 to the sink 511 (1006). If encryption is unnecessary (1004 returns no), the session manager 502 outputs the decrypted content through the I/O port 501 to the sink 511 (1007).

FIG. 5 is a flow chart showing another example of the transcoding process of a secure container according to this first embodiment of the invention. Steps 1201, 1202, 1203, and 1204 are the same as steps 1001, 1002, 1003, and 1004 in FIG. 4, and further description thereof is thus omitted. Whether transcoding the content being processed is completed is determined in step 1205 in FIG. 5. If processing continues (1205 returns no), control returns to step 1202 and the transcoding process repeats. Transcoding can thus be applied to streaming and cyclical content.

Furthermore, a secure connection can be established using an open source, widely used method by using the Diffie-Hellman key agreement protocol to open a secure connected (d) between the secure container 500 and sink 511.

Control commands defining the encryption strength of the secure data channel used to send data to the sink can also be included in the command set (usage rules) in the step (f) for sending data to the sink 511. This enables using the command set to manage the encryption strength (that is, the strength of the secure channel between the secure container 500 and sink), and makes it possible to improve safety more flexibly according to the data channel type.

A command set denoting the period for which the secure channel for sending data to the sink is valid can also be contained in the command set (usage rules) in the step (f) for sending data to the sink. The command set for managing encryption (a secure channel between the secure container 500 and sink) can therefore specify for how long the encryption in step 1004 is valid. This makes it possible to construct a purchasing system enabling customers to copy and save broadcast data, for example, for personal use for a certain purchasing period, or a purchasing system enabling the planned use of data.

A command set indicating how many copies of the data are sent to the sink can also be included in the command set (usage rules) in the step (f) for sending data to the sink. The command set for managing encryption (a secure channel between the secure container 500 and sink) can therefore manage such restrictions as specifying how many copies can be sent, how many backup copies can be made, and how many times data can be shared.

Part or all of the command set sent from the source in step (c) can also be included in the command set sent to the sink in step (f). This enables adding control commands sent from the source to the secure container, and has the effect of enabling the source to specify the security conditions. The default conditions defined in the command set attached to the license or key are never weakened, however.

Furthermore, a control command indicating the conditions to be applied by the sink before data is sent to the sink can also be included in the command set sent to the sink in step (f). This enables a control command for managing encryption (a secure channel between the secure container and sink) to define conditions for the sink, and as a result enables the source to specify conditions for the sink. The source could, for example, specify that the sink must conform to a certain security standard, such as requiring user confirmation for high cost data, in order to complete a purchase.

A secure connection (d) between the secure container and sink can also be opened using CPRM (Content Protection of Recordable Media). Using CPRM enables using this system in all CPRM-compatible environments, including SD cards.

The step (c) for sending a command set from the source to the secure container can also be omitted. This enables using this system when the source is simple a basic storage device or recording medium.

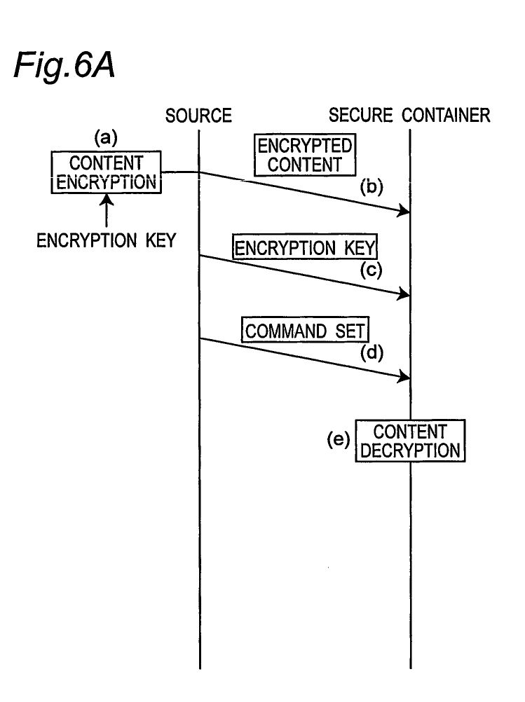

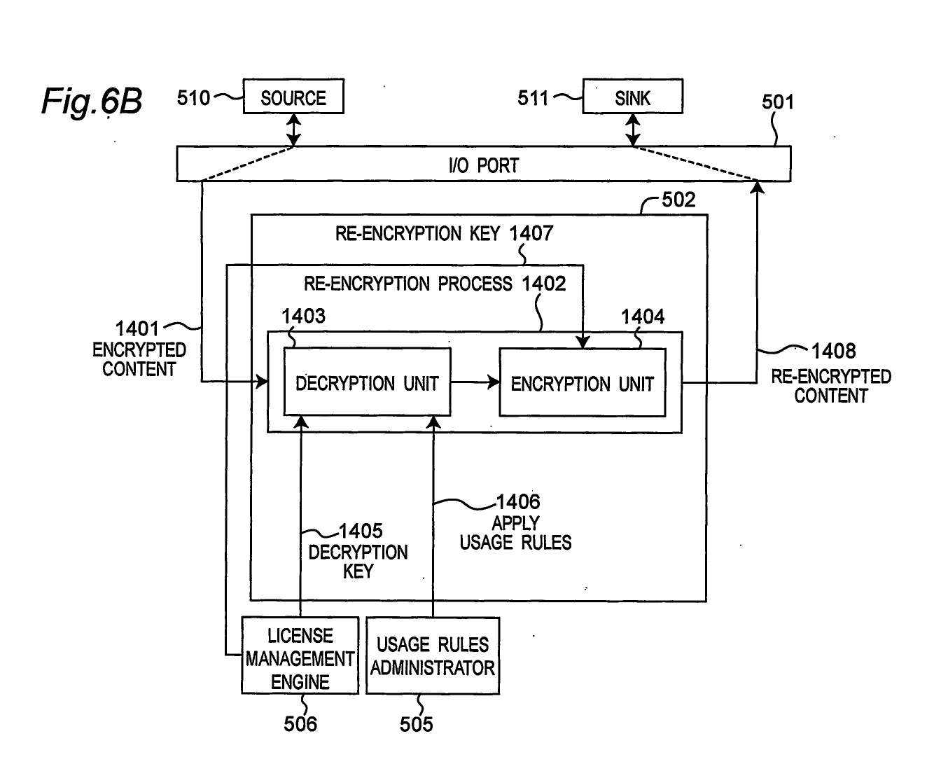

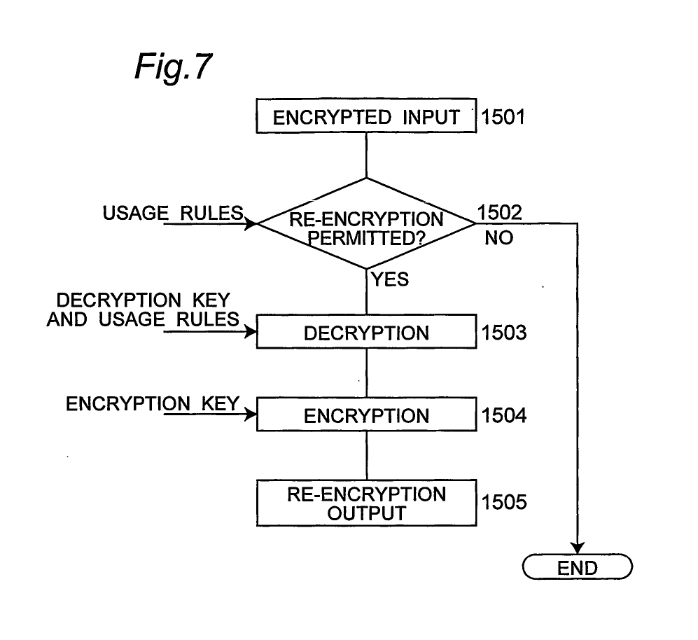

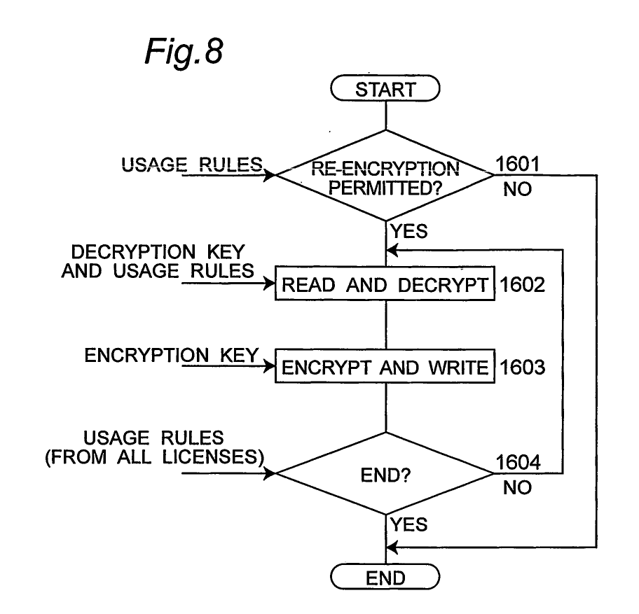

An example of a method for sending re-encrypted digital data (content) from a source to a sink by way of a secure container according to this first embodiment of the present invention is described next with reference to FIG. 6A, FIG. 6B, FIG. 7, and FIG. 8.

Three data sets are defined in the re-encryption process when sending content from a source to a sink through a secure container 500. These three data sets are the content 1401 (encrypted using a particular key), the key 1407 used to encrypt the content, and a command set used for control operations in the secure container 500. These command sets are sent from the source to the secure container 500, but the timing at which they are sent and the communication means do not need to be the same, and can be sent on different buses. The secure container 500 uses these data sets for re-encryption, and because a key specific to the sink is used for re-encryption in the re-encryption process, only that sink can decrypt the content.

As shown in FIG. 6A, the transfer process from the source to the sink for the re-encrypted content is composed of the following five steps. That is, (a) the source encrypts the content using the key linked to the content, (b) the encrypted content 1401 is sent from the source to the secure container, (c) the key used for encryption in step (a) is sent to the secure container, (d) a command set is sent from the source to the secure container, and (e) the content 1401 is decrypted using the key assigned to the content, and the content is then re-encrypted using the key assigned to the sink. The decryption and re-encryption step (e) is controlled by the command set stored in the secure container. The key in step (c) can also be sent as part of the associated license sent or received earlier.

FIG. 6B describes the re-encryption process in step (e) executed in a secure container according to this first embodiment of the invention. The secure container 500 receives encrypted content 1401, runs the re-encryption process 1402, and outputs re-encrypted content 1408. This re-encryption process 1402 includes decryption 1403 and encryption 1404. Content 1401 encrypted with a key linked to the license (i.e., decryption key 1405) is input to the session manager 502 and decrypted using the decryption key 1405. Associated usage rules 1406 are then applied to re-encrypt the decrypted content using the re-encryption key 1407 linked to the license, and the re-encrypted content is then output. This re-encryption key 1407 is generated based on the license, and is therefore acquired from the license management engine 506. The re-encrypted content 1408 is output to the sink 511 through the I/O port 501. The sink 511 then records the re-encrypted content, or decodes and plays the content.

FIG. 7 is a flow chart showing an example of the re-encryption process run by a secure container according to this first embodiment of the invention.

The session manager 502 first receives encrypted content from the source through I/O port 501, and stores the received content to memory 504 (1501).

The license management engine 506 then acquires the license data linked to the content from memory 504, and sends the license to the usage rules administrator 505. The usage rules administrator 505 determines the usage rules based on this license, and applies the usage rules to determine whether re-encryption is allowed (1502).

If re-encryption is not allowed (1502 returns no), the process ends. If re-encryption is allowed (1502 returns yes), the encryption engine 507 uses the decryption key to code the encrypted content (1503).

The encryption engine 507 applies the associated usage rules and re-encrypts the decoded content using the decryption key from the license (1504). The session manager 502 then outputs the re-encrypted content through I/O port 501 (1505).

FIG. 8 is a flow chart showing an example of a re-encryption process for cyclical content run by a secure container according to this first embodiment of the invention. First, the session manager 502 receives encrypted content from a source through the I/O port 501, and saves the content to memory 504, or sends the same to sink 511.

The license management engine 506 then reads the license data for the encrypted content from memory 504, and sends the license data to the usage rules administrator 505. The usage rules administrator 505 determines the usage rules based on this license data, and applies these usage rules to determine if re-encryption is allowed (1601).

If re-encryption is not allowed (1601 returns no), the process ends. If re-encryption is allowed (1601 returns yes), the encryption engine 507 reads part of the encrypted content from memory 504, and using the decryption key decodes the red encrypted content (1602).

The encryption engine 507 then applies the related usage rules to re-encrypt the decoded part of the content, and the session manager 502 outputs the re-encrypted content through the I/O port 501 (1603).

Next, the usage rules administrator 505 again applies the usage rules to determine if re-encrypting the next part of the content is allowed (1604). If re-encrypting the next part of the content is allowed (1604 returns no), control returns to step 1602 and processing continues. However, if re-encryption is not allowed (1604 returns yes), processing ends. Note that step 1604 determines that re-encryption is not allowed and processing therefore ends when processing the last of the content has ended.

Content can thus be individualized to a particular user as a result of the user re-encrypting the content, and the content can thus not be used by a different party. The re-encryption process can also anonymously encrypt the content.

A control command defining the calculation time allowed for re-encryption can also be included in the command set (usage rules) in step (e). This enables the control commands for managing re-encryption to specify the period allowed for re-encryption. This affords constructing a commerce system that allows a customer to copy and save broadcast data, for example, for personal use for a specified purchasing period.

Furthermore, control commands specifying how many re-encrypted copies of the data can be generated can also be included in the command set in step (e). This enables the control commands for managing re-encryption to specify the number of allowed copies, and thereby limit and manage the number of valid copies that can be made for data backup or sharing. Furthermore, because the content is linked to a unique customer, monitoring and auditing are possible.

Furthermore, control commands denoting the conditions that must be applied by the sink before re-encryption is allowed can also be included in the command set in step (e). This enables the control commands for managing re-encryption to define specific conditions for the sink, and as a result the source can define conditions to be applied by the sink. The source could, for example, specify that the sink must conform to a specific security standard in order to purchase certain high cost data.

The encryption key sent in step (c) could also be included in the command set in step (e). Control commands specifying the number of times re-encrypted data can be copied must be sent from the source and are not part of the control command set built in to the sink. These control commands can be validly defined by including them in the command set.

Step (e) can be controlled at least in part by the command set of the source. In this case the control commands are stored in the source and encryption occurs on the source side. This enables the source corresponding to the data creator or owner to completely control the re-encryption process. Furthermore, storing the control commands for managing re-encryption in the sink has the effect of enabling the sink to control re-encryption independently.

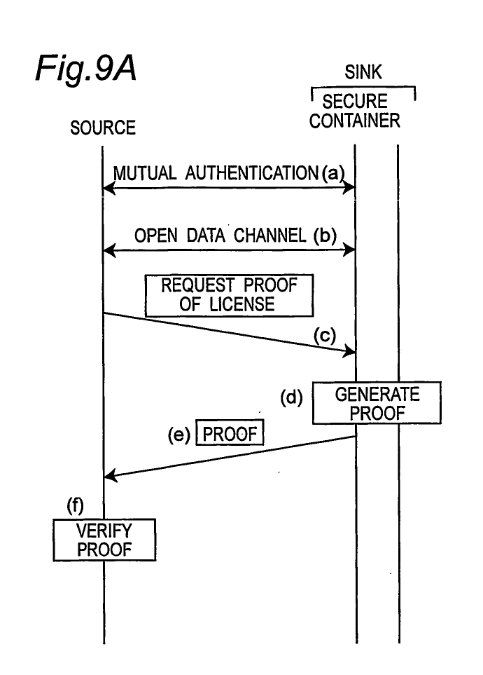

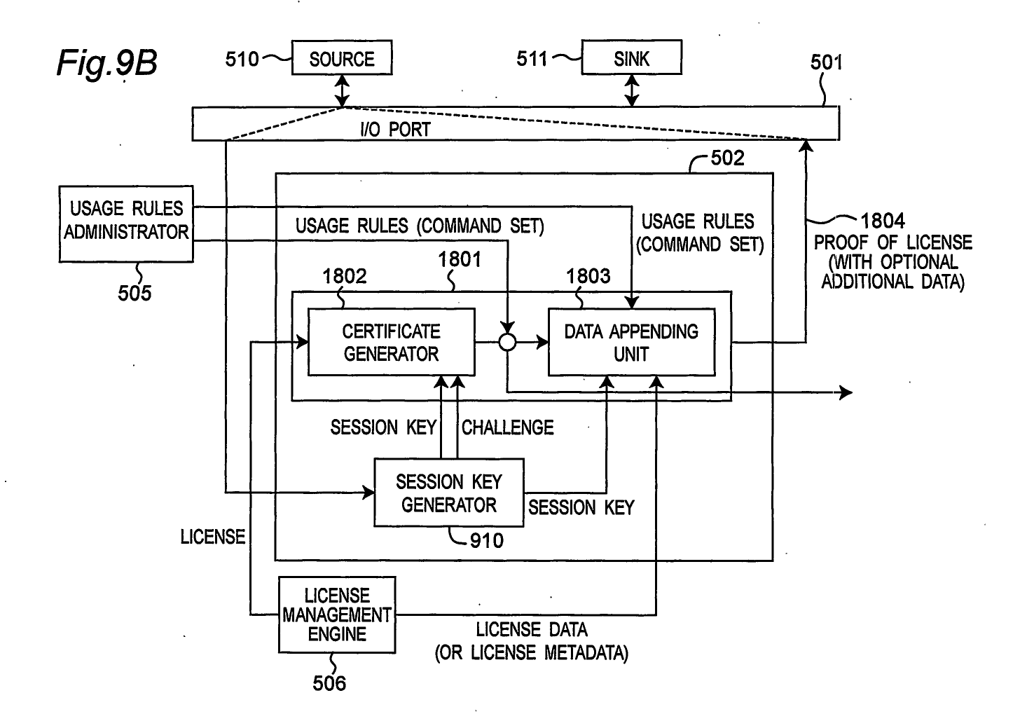

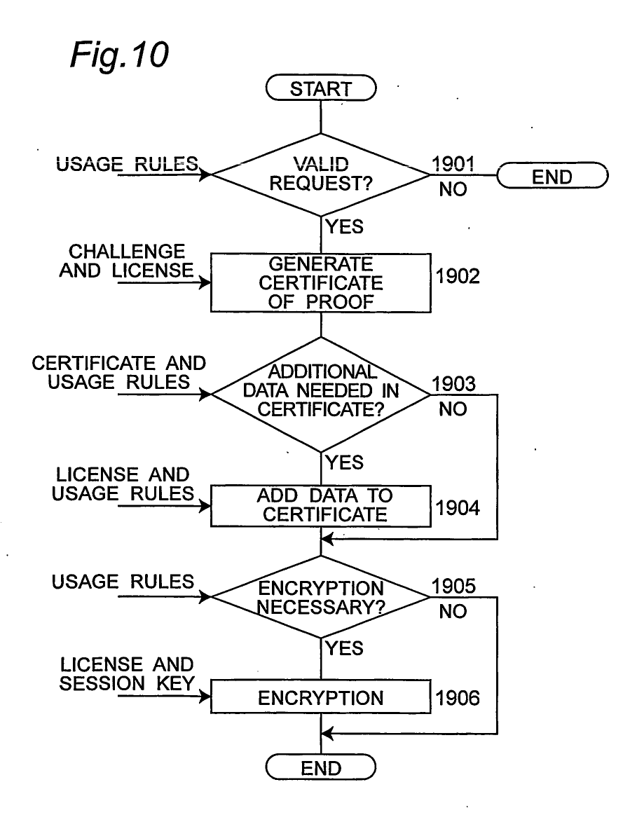

An example of a method for verifying the presence of a license in a secure container according to this first embodiment of the present invention is described next with reference to FIG. 9A, FIG. 9B, and FIG. 10. Note that with this method the secure container is assembled in the sink, and the presence of a license is verified without disclosing to the source the details of the license stored in the sink.

If the source wants to obtain verification that a valid license is stored in the license pool of the sink, the source must request the sink to send a certificate of proof using a secure channel. The sink 511 (secure container 500) generates a proof certificate referenced to the request (challenge) sent from the source 510 to the sink 511. The sink 511 then sends the generated certificate over a secure channel to the source 510.

This challenge is used in a challenge-response protocol, which is a type of authentication protocol. The client (sink) DRM system signs the challenge using the secret key embedded in the license. The server (source) verifies the signature using the public key that is also part of the license, and could also be associated with the license. The server can thus verify whether the DRM system has a license and is responding to the request with the correct credentials. For example, the user could enter h is own secret code (challenge) in a smart card and acquire a new code (response) for logging in to another system.

As shown in FIG. 9A the process for proving that a license is present is divided into six steps: (a) mutual authentication by the source and sink; (b) opening a secure data channel between the source and sink; (c) sending a challenge, which is a request for proof of a license; (d) the sink generating unique proof using the challenge and license data; (e) sending the unique proof to the source, and (f) the source verifying the proof received in the response.

FIG. 9B shows the process for generating proof of a license in step (d) above in a secure container according to this first embodiment of the invention. The session manager 502 receives a challenge from the source 510 in the session in which proof of license is requested, and the processor 1801 runs a process for generating proof of a license and outputs the resulting proof of license 1804. The processor 1801 that generates the proof of license proving that the license exists is composed of a certificate generator 1802 that generates a certificate (response) containing the necessary information from the license, and a data appending unit 1803 for adding data for optional items in the license. When proof of license is requested by the source 510, the session key generator 910 generates a session key and challenge. The license output from the license management engine 506 is sent to the certificate generator 1802. It should be noted that the license Is assumed to be stored in memory 504. The certificate generator 1802 generates the certificate of proof using the session key and challenge. The usage rules from the usage rules administrator 505 are then applied to the resulting certificate as required. If the license contains optional items, the data appending unit 1803 adds metadata and additional license data from the license management engine 506 to the certificate. This new certificate is then encrypted using the session key as may be necessary, and the encrypted proof of license 1804 is then output. The output proof of license 1804 does not communicate the content of the license itself, but instead simply proves that the content of the license is correct. The output proof of license 1804 is sent through the I/O port 501 to the source 510. The source 510 can thus confirm by executing steps (c), (d), and (e) in FIG. 9A that the sink or secure container 500 has an appropriate license.

Disclosing license content in this proof or certificate when it is necessary to show that a license is owned could result in the illegal use of or tampering with the content. As a result, when it is not necessary to disclose the content of the license, this proof or certificate simply shows proof that a valid license is present. For example, what is important with electronic tickets is proof that a valid ticket is held, and it is therefore not necessary to disclose the encrypted content.

Metadata is data that is not directly related to the license or certificate of proof in the case of an electronic ticket for a movie theater, for example, metadata is used to denote such additional information as the seat number and free drinks, but is not limited thereto.

FIG. 10 is a flow chart showing an example of the process for generating proof of a license in a secure container according to this first embodiment of the invention. First, the session manager 502 receives through the I/O port 501 and starts processing a challenge from the source 510 requesting proof of a license.

The license management engine 506 gets the requested license from memory 504 (license pool), and passes the acquired license data to the usage rules administrator 505. The usage rules administrator 505 determines the usage rules based on the received license data, applies the usage rules, and determines whether the challenge is valid or not (1901).

If the challenge is invalid (1901 returns no), processing ends. The request (challenge) is also treated as invalid and processing ends if the requested license is not stored in memory 504. If the request is valid (1901 returns yes), the certificate generator 1802 and data appending unit 1803 generate the certificate of proof using the license and challenge (1902, 1903, 1904, 1905, 1906). More specifically, a certificate containing the basic license items is generated first (1902). Whether there are any optional license items is then determined (1903), and if there are those items are added (1904). Whether the generated certificate needs encrypting is then determined (1905), and the certificate is encrypted if necessary (1906). It should be noted that the data appending unit 1803 could be omitted and the certificate generator 1802 configured to generate a certificate containing both the basic license items and optional items.

The usage rules administrator 505 then applies the usage rules and determines if it is necessary to add additional data to the certificate (1903). If adding additional data is necessary (1903 returns yes), the license management engine 506 extracts the data to be added from the license and adds the data to the certificate (1904).

The usage rules administrator 505 then applies the usage rules to determine if encrypting the certificate is necessary (1905). If encryption is needed (1905 returns yes), the encryption engine 507 encrypts the certificate using the session key (1906). Finally, the session manager 502 outputs the generated certificate through the I/O port 501 to the source 510.

It should be noted that whether the request is valid or not based on the usage rules refers, in the case of using electronic tickets, the expiration date and number of times the ticket can be used written in the usage rules, and if applicable determining that the tickets are valid usable tickets. Whether the license is valid was determined in this example using the usage rules, but the name and creation date of the license data file can be evaluated by the system or external device.

Using electronic tickets for a movie theater, for example, optional data could be markings for selecting people to survey for comments after viewing a movie, but shall not be so limited.

The advantage of issuing a certificate unique to a particular license is that it is not necessary for the sink to send detailed license information to the source. This certificate can also be used in an electronic ticket system using a license instead of e-tickets.

Furthermore, by using the Diffie-Hellman key agreement protocol to open a secure connection (b) between the secure container and sink, a secure connection can be opened using a common, open source method.

The secure connection (b) between the secure container and sink can also be opened using CPRM. Using CPRM enables using this system in all CPRM-compatible environments, including SD cards.

The step (d) for generating a certificate is controlled by a command set. This enables the control command for managing certificate generation to affect how the certificate is generated, and enables the license issuer to control how the certificate is generated.

A one-way hash function can be used in the step (d) for generating the certificate, thus making it possible to generate an encrypted secure certificate.

The challenge and certificate can be encrypted using a public key from the source in the step (d) for generating a certificate. The advantage of this is that the connection between the source and secure container need not be secure. Security in this case is afforded by the public key encryption method. The public key of the source can be embedded in the license in this case.

Before sending the certificate to the source in step (d) for generating a certificate, the certificate can be encrypted using a key embedded in the license. In this case only the license issuer and a trusted third party can decrypt the certificate. Furthermore, if the source can decode the certificate, the source can be considered to be a permitted party, and the source does not need to verify itself to the secure container.

Furthermore, in the step (d) for sending the certificate to the source, the certificate can be sent to the source together with additional data embedded in the license. An electronic ticket is thereby afforded.

Furthermore, before sending to the source a certificate to which additional data contained in the license has been attached, the certificate or attached data, or both, can be encrypted using the key (session key) embedded in the license. An electronic ticket is thereby afforded.

Information indicating what data contained in the license should be added to the certificate can also be included in the command set. This enables including in the control command managing certificate generation information indicating what data contained in the license should be included in the certificate, thereby making it possible to attach to the certificate specific metadata embedded in the license, such as the content expiration date and valid region code.

Random data can also be included in the command set. More specifically, random data is added to the certificate, and the certificate is then encrypted. The advantage of this is that the encrypted randomized certificate can be made to look like random data, thereby eliminating any apparent correlation to another previously delivered license certificate.

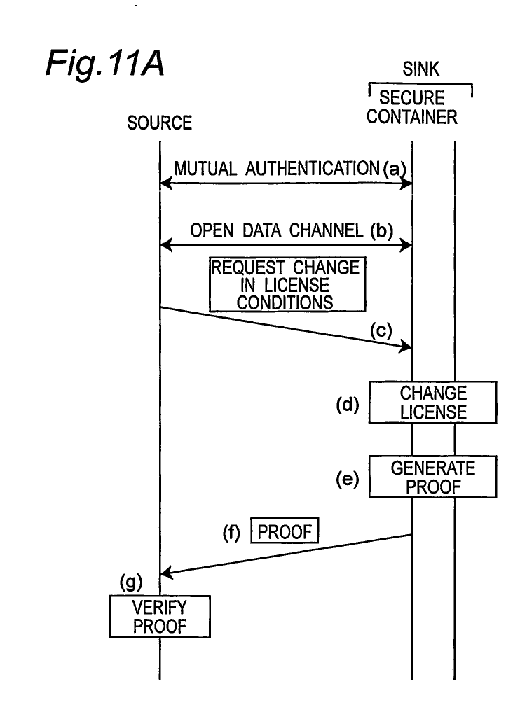

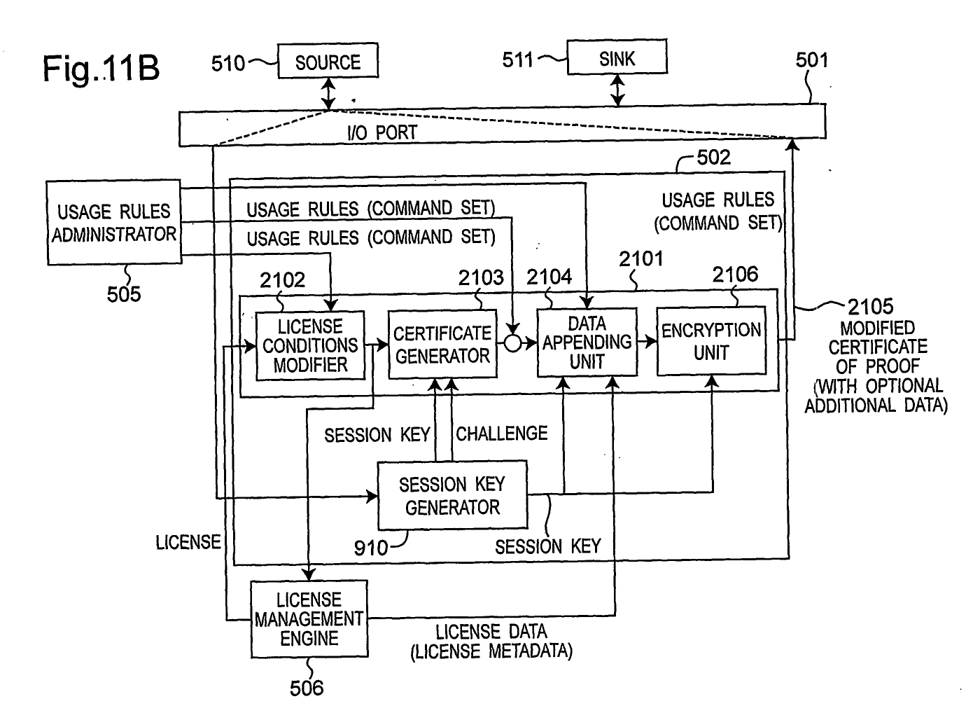

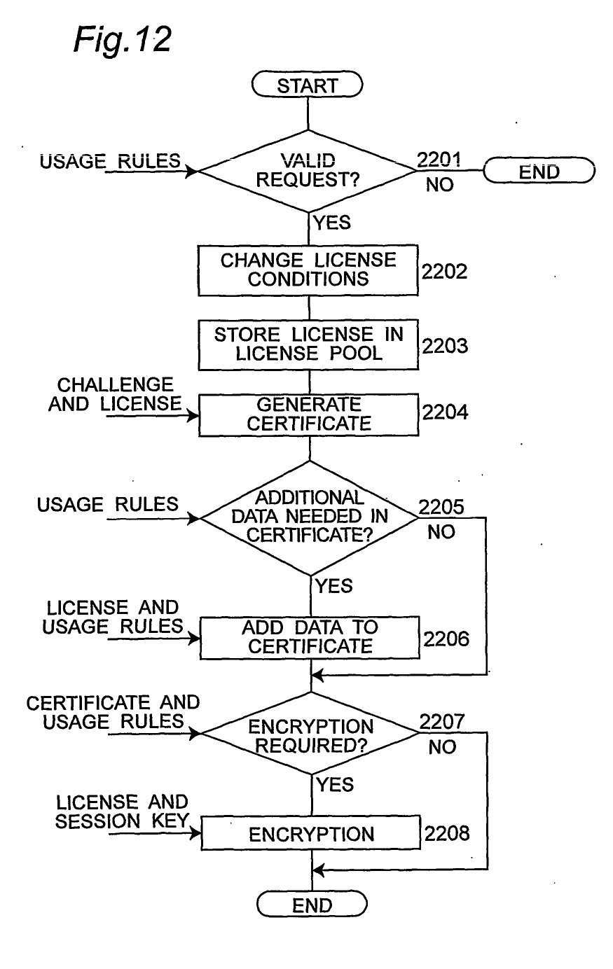

An example of a method for changing licensing condition information in a secure container according to this first embodiment of the invention is described next with reference to FIG. 11A, FIG. 11B, and FIG. 12. This licensing condition information is allocated to a license as needed or is embedded in the license. To change the licensing condition information, a secure channel is first established between the source and secure container by mutual authentication. A request to change the licensing condition information is then sent from the source to the secure container, and the secure container processes the received request. If changing the licensing condition information is successful, the secure container sends the changed certificate to the source. Using this certificate, the source can verify the result of the requested change. Note that the secure container is assumed to be in the sink.

As shown in FIG. 11A, the process for changing licensing condition information has seven steps: (a) mutual verification by the source and sink; (b) opening a secure data channel between the source and sink; (c) sending a request to change the licensing condition information and a challenge to the sink; (d) the sink applying the requested change to the license; (e) the source generating a unique certificate using the challenge and license data; (f) sending the resulting unique certificate to the source; and (g) the source verifying the received certificate.

FIG. 11B schematically illustrates a process run by a secure container according to this first embodiment of the invention to generate proof of license and then change that license. The session manager 502 receives a challenge from the source 510 in the session requesting proof of a license, runs a process to generate proof of a license, runs a process 2101 to change the license, and outputs the generated certificate 2105. The processor 2101 that generates this proof of license and then changes the license is composed of a processor 2102 for changing the licensing condition information, a processor 2103 for generating the proof, and a processor 2104 for adding data. The request to change the licensing condition information and the challenge are sent to the session manager 502, a license is acquired from the license management engine 506, and the license data is then modified according to the received change request. The license stored in the license management engine 506 is updated to this modified license, and a certificate is generated using this challenge. The related usage rules from the usage rules administrator 505 are then applied, and if there is a request, data and metadata from the license is added to the certificate. If necessary, the newly generated certificate is also encrypted by an encryption unit 2106 using the session key, and this certificate 2105 is output. Note that the usage rules are also applied to the output data packets (denoting the certificate 2105).

FIG. 12 is a flow chart of an exemplary process run by a secure container according to this first embodiment of the invention to change the license and generate proof of a license. First, the session manager 502 receives from the source and starts processing a request to change the licensing condition information and a request for proof of license.

The license management engine 506 reads the corresponding license from memory 504 (license pool), and passes the retrieved license data to the usage rules administrator 505. The usage rules administrator 505 determines the usage rules based on the received license data, applies the usage rules, and determines whether the challenge is valid or not (2201).

If the challenge (request) is invalid (2201 returns no), processing ends. The request is also determined invalid and processing ends if the corresponding license is not stored in memory 504. If the request is valid (2201 returns yes), the license management engine 506 changes the licensing condition information based on the received request to change the licensing condition information (2202), and the license stored in memory 504 (license pool) is updated to the changed license (2203).

The encryption engine 507 then generates the certificate using the license and challenge (2204).

The usage rules administrator 505 then applies the usage rules to determine whether additional data must be added to the certificate (2205). If the additional data is necessary (2205 returns yes), the license management engine 506 extracts the data to be added from the license, and adds the data to the certificate (2206). If adding the data is not necessary (2205 returns no), the data is not attached.

The usage rules administrator 505 the applies the usage rules to determine whether encrypting the certificate is needed (2207). If encryption is needed (2207 returns yes), the encryption engine 507 encrypts the certificate using the session key (2208). Finally, the session manager 502 sends the resulting certificate through the I/O port 501 to the source 510.

Examples of when changing the license conditions is necessary include annual licenses and membership services for which the validity of a license is extended by paying an annual membership fee, for example. Specific examples include software licenses and subscriptions to on-line magazines. Other examples related to multiple electronic tickets, for example, include application to train tickets that can be used ten times within a certain period. In this case the licensing conditions are changed to decrement the number of remaining uses each time the ticket is used, and to invalidate the ticket when the expiration date is reached.

Advantages of this method include the ability to provide two-way or multiple electronic tickets by changing the licensing condition information, and the ability to restrict use of digital data covered by a license. These benefits are further described below.

In a system that permits changing the license, the possibility of license changes not managed by the system increases, and security-related dangers increase. However, by including one or more changeable values in the license, and defining the method of changing the license and the range of valid changes in the usage rules, these security-related dangers can be decreased and the license can be safely changed.

An example of license conditions is a round-trip ticket where the out-bound part is one license condition and the return part is a second condition. The round-trip ticket is automatically invalidated once the return portion is used. If changing only the license conditions is permitted, security can be improved by protecting the key for decoding the content. Another example is a license defining as conditions the number of time and the time period during which movie content can be played back. If digital data is used for the movie content, the license conditions information is updated until defined conditions are reached. When the playback count and time reach the defined conditions, the license becomes invalid and the digital data can no longer be used.

Furthermore, by using the Diffie-Hellman key agreement protocol to open a secure connection (b) between the secure container and sink, a secure connection can be opened using a common, open source method.

The secure connection (b) between the secure container and sink can also be opened using CPRM. Using CPRM enables using this system in all CPRM-compatible environments, including SD cards.

The step (e) for generating a certificate is controlled by a command set. This enables the control command for managing certificate generation to affect how the certificate is generated, and enables the license issuer to control how the certificate is generated.

A one-way hash function can be used in the step (e) for generating the certificate, thus making it possible to generate an encrypted secure certificate.

The challenge and certificate can be encrypted using a public key from the source in the step (e) for generating a certificate. The advantage of this is that the connection between the source and secure container need not be secure. Security in this case is afforded by the public key encryption method. The public key of the source can be embedded in the license in this case.

Before sending the certificate to the source in step (e) for generating a certificate, the certificate can be encrypted using a key embedded in the license. In this case only the license issuer and a trusted third party can decrypt the certificate. Furthermore, if the source can decode the certificate, the source can be considered to be a permitted party, and the source does not need to verify itself to the secure container.

Furthermore, in the step (e) for sending the certificate to the source, the certificate can be sent to the source together with additional data embedded in the license. An electronic ticket is thereby afforded.

Furthermore, before sending to the source a certificate to which additional data contained in the license has been attached, the certificate or attached data, or both, can be encrypted using the key (session key) embedded in the license. An electronic ticket is thereby afforded.

Information indicating what data contained in the license should be added to the certificate can also be included in the command set. This enables adding to the certificate specific metadata contained in the license.

Random data can also be included in the command set. More specifically, random data is added to the certificate, and the certificate is then encrypted. The advantage of this is that the encrypted randomized certificate can be made to look like random data, thereby eliminating any apparent correlation to another previously delivered license certificate.

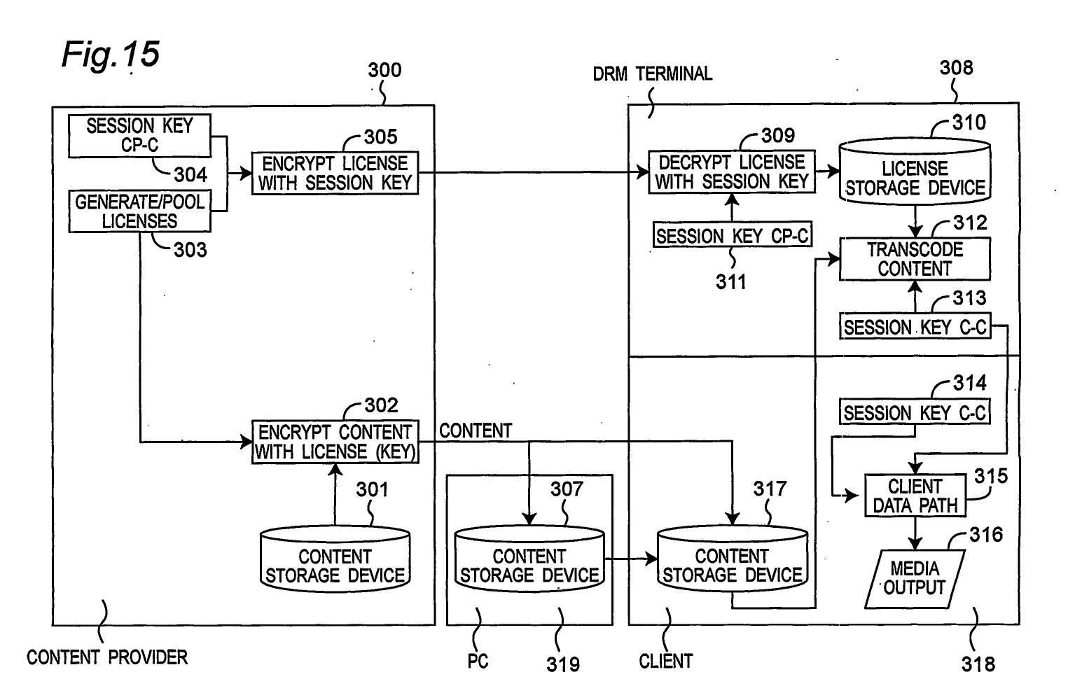

FIG. 15 is a schematic diagram of a system according to this first embodiment of the invention. This system is composed of at least two components, the content provider 300, which is and is referred to below as a server, and a client 318 containing a DRM (digital rights management) terminal 308. A PC 319 could also be included for storing content received from the server. The server 300 and client 318 can be connected over a network, and the client 318 is a device for processing, including storing and playing, content acquired from the server 300 over the network. When content is acquired from the content storage device 301 of the server 300, the server 300 encrypts the content to be distributed using a license (key) 303 linked to the content. This license 303 is encrypted (305) using a session key 304 defined in the session between the DRM terminal 308 and server 300, and the encrypted license is then sent to the DRM terminal 308. The DRM terminal 308 receives the encrypted license, decodes the license using the session key 311 (309), and stores the decrypted license in the license storage device 310. It should be noted that the license is decrypted using the session key in this example, but the encrypted license could be stored in the license storage device 310.

Content acquired from the server 300 is stored in the content storage device 317 of the client 318. Note that the content could be stored in a content storage device 307 of the PC 319. To play this content acquired from the server 300, the content to be played is communicated to the DRM terminal 308, and the content is then decrypted using the related license stored in license storage device 310 (312). Transcoding (312) whereby the content is re-encrypted after decrypting could also be used. A session key 313 defined in this session between the DRM terminal 308 and client 318 is used for transcoding. The client 318 acquires content from the DRM terminal 308, decrypts the content using a session key 314 as needed, and outputs the decrypted content to some medium, such as playing the acquired content.

The license 301 includes usage rules or an encrypted part. The license key 302 is one part related to license 301 encryption, and more than one license key can be included in a license.

A client 318 could be an end-user device or any other device for acquiring content. The DRM terminal 308 is a DRM system rendered in the client 318, and could be fixed in the client 318 or it could be removable. A memory card containing the DRM system is one example of a removable configuration.

A session key is a temporary key used for encryption and decryption to assure a secure connection. A session key is only valid for the time and place in which a session, that is a communicating connection, is open.

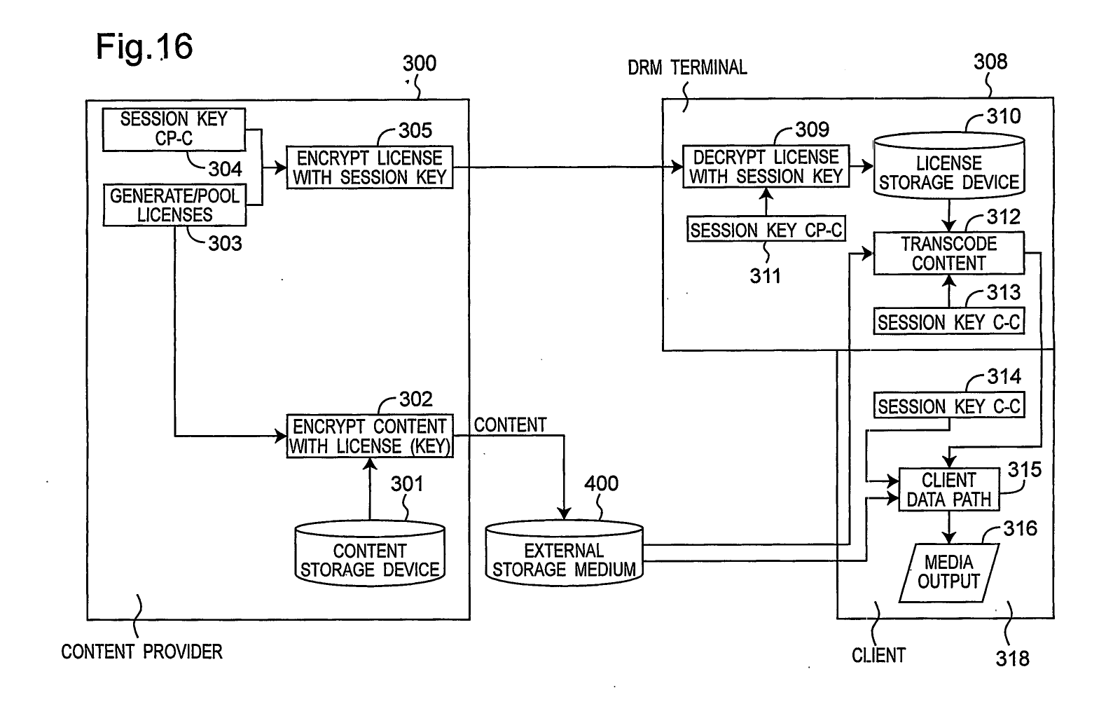

FIG. 16 is a schematic diagram of another system according to this first embodiment of the invention. This system is composed of at least three components, the content provider 300, which is and is referred to below as a server, a client 318 containing a DRM terminal 308, and an external storage medium 400. This system is basically the same as the system shown in FIG. 15, and differs in that content data is only stored on external storage medium 400 (or an external storage device). To play content acquired from the server 300, the content to be played is sent from the external storage medium 400 to the DRM terminal 308 of the client 318, and is decrypted (312) using the related license stored in the license storage device 310.

Transcoding (312) whereby the content is re-encrypted after decrypting could also be used. A session key 313 defined in this session between the DRM terminal 308 and client 318 is used for transcoding. The client 318 acquires content from the DRM terminal 308, decrypts the content using a session key 314 as needed, and outputs the decrypted content to some medium, such as playing the acquired content.

A user could, for example, use a card-based system to purchase a license on-line. When authentication for making a purchase is completed, the system opens a secure connection with the license issuer (server 300). The requested license data is then encrypted and sent to the system. The system then decrypts (309) the encrypted license data, confirms that it is valid, and then stores the license data in license storage device 310. If the command set, that is, usage rules, indicate storing the license in the encrypted state, the license is encrypted using a unique secret device key built in to the system, and then stores the encrypted data in the license storage device 310.

If the user wants to play audio content, for example, the DRM terminal 308 first attempts authentication, and if authentication succeeds, opens a secure connection with the user's client playback device (client 318), and prepares session keys (313, 314). When the session keys (313, 314) are issued, the desired content is sent to the DRM terminal 308. The content is decrypted (312) using a key embedded in the license and re-encrypted (312) using the session key, and then sent to the client playback device (client 318). Content sent from the DRM-terminal 308 to the client 318 is decrypted using a specific session key 314, a client data path (315) is processed, and the decrypted content is then sent to the media output 316 of the client 318.

If it is necessary to re-encrypt licensed content correlated to a new license, the content is first sent from the client 318 to the DRM terminal 308, decrypted using the existing license, then re-encrypted using a newly issued license, and then returned to the client 318. In this case the content re-encryption process is controlled and verified using the command set (usage rules) associated with the original license.

If as part of an electronic ticket service, for example, the rights holder requests that proof of license be issued to the DRM system, it is not necessary with the present invention to send to the client any more license data than is needed to prove that a license is owned. When the client or rights holder succeeds in authentication with the DRM system, a secure connection is opened between them and a session key is created. When the rights holder or client requests the DRM system for proof, the DRM system generates a certificate. Optional data can also be included in this certificate. If the control command set attached to the license, that is, the usage rules, can prove there is a license, it can also affect generating the certificate. The control command set could, for example, request that a different certificate be issued for each certificate request, or that the certificates are random, and can thereby affect the creation of certificates.

If the rights holder requests a change in the license conditions, such as requesting multiple electronic tickets, control commands for the requested change are included in the request for a proof of license. What kinds of changes are to be applied to the license conditions are defined in these control commands. The DRM system applies the requested changes, and returns a license certificate to which the updated rules data has been added to the party requesting the certificate.

### Second Embodiment

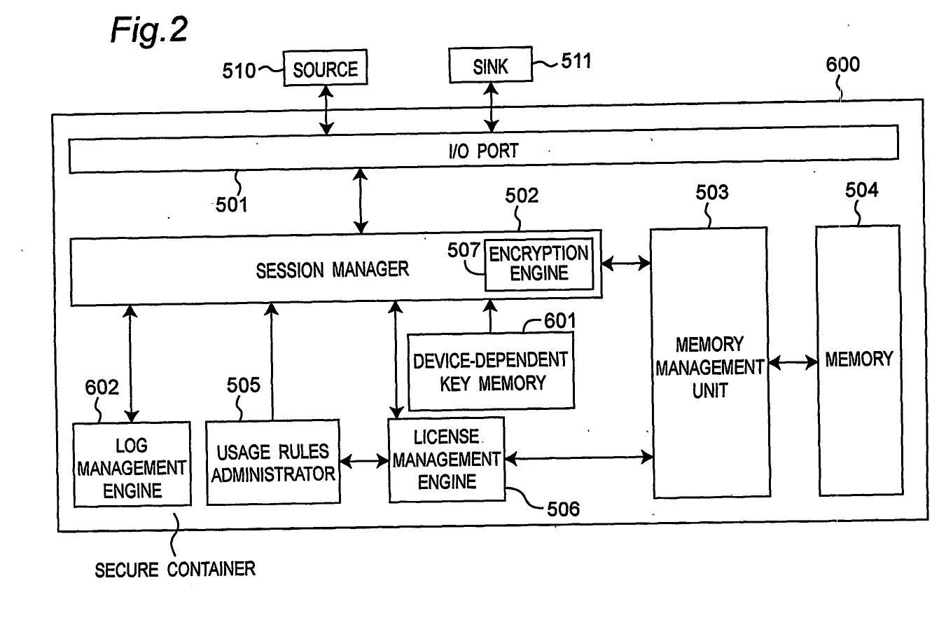

FIG. 2 is a function block diagram showing the configuration of a secure container according to a second embodiment of the present invention.

This secure container 600 is the same as a secure container according to the first embodiment in having an I/O port 501, session manager 502, license management engine 506, usage rules administrator 505, encryption engine 507, memory management unit 503, and memory 504, but differs in additionally having a device-dependent key memory 601 and log management engine 602.

The additional components of this second embodiment of the invention are described below.

The device-dependent key memory 601 can store not just one but multiple keys unique to each client system for encryption and decryption. When the encryption engine 507 encrypts and decrypts license data using a shared key encryption algorithm, it uses a device-dependent key from this device-dependent key memory 601. A device-dependent key is unique to each device, and is hard coded or prestored in the device. If the device-dependent key does not reference user information, it is considered anonymous. If a license is anonymously stored, a device-dependent key or built-in key is used.

The log management engine 602 records and stores changes in license conditions processed by the secure container as log data. Log data from communication transactions during a session, encryption and decryption processes run by the encryption engine 507, and other security related processes is received from the session manager 502 and recorded and stored as log data.

This enables encrypting content using a key unique to the system, and provides greater protection against data theft and tampering. Furthermore, the system manufacturer or trusted third party can recognize when the secure container or digital license data stored in the secure container has been tampered with or abused.

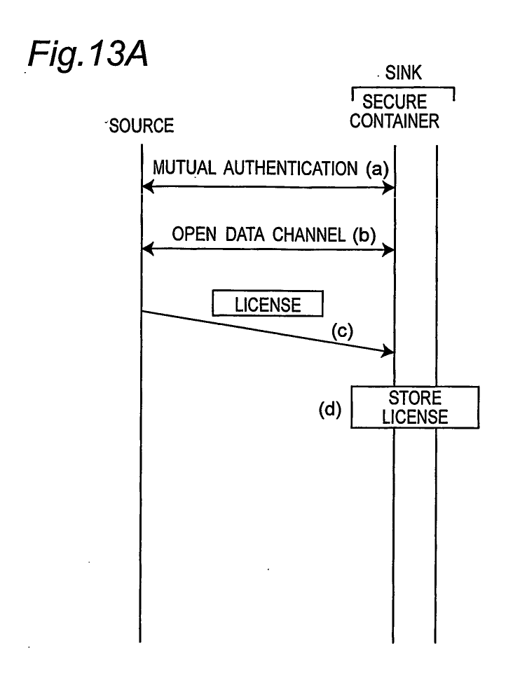

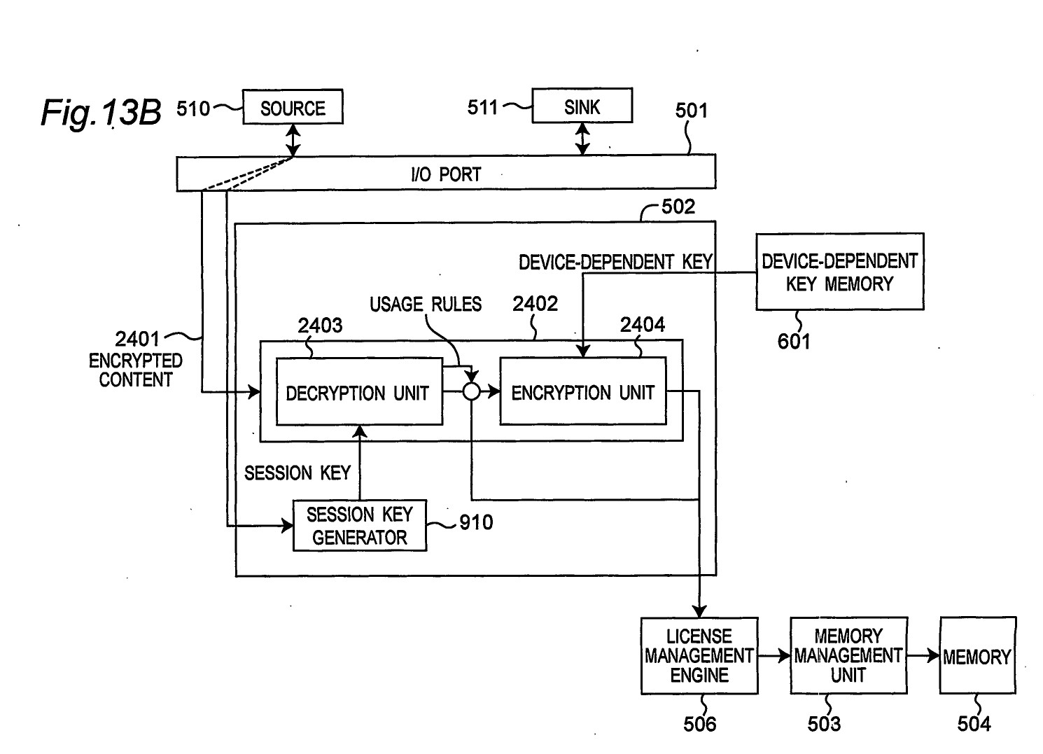

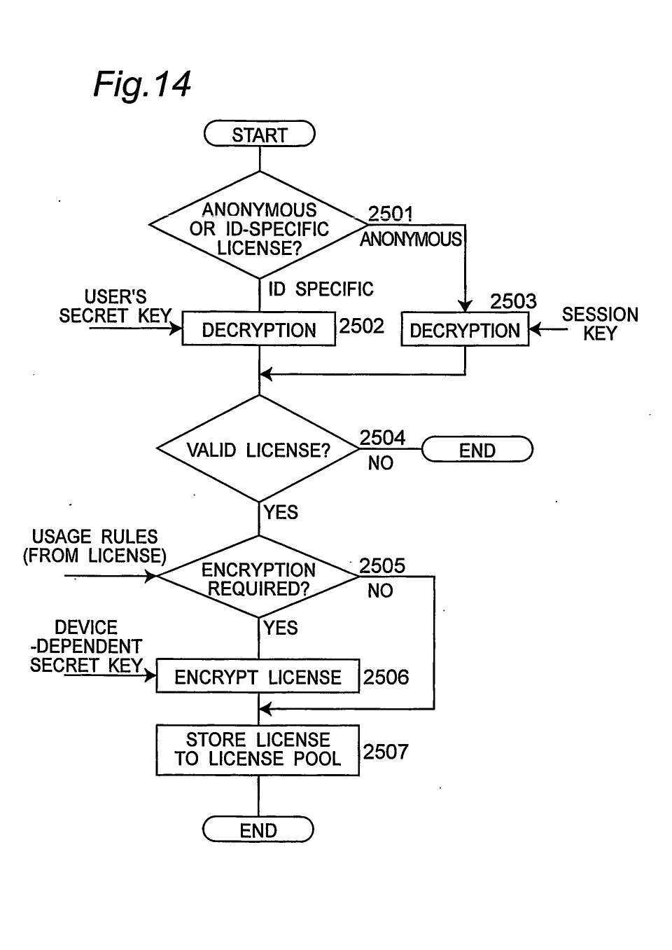

An example of a method for storing licenses in a secure container according to this second embodiment of the present invention is described below with reference to FIG. 13A, FIG. 13B, and FIG. 14. A secure channel is established when mutual authentication by the secure container and source succeeds. License data received through this secure channel is stored in internal memory inside the secure container. The secure container is assumed to be in the sink.

As shown in FIG. 13A, the process for storing a license has four steps: (a) mutual authentication by the source and sink, (b) opening a secure data channel between the source and sink, (c) sending the license from the source to the sink over the secure data channel, and (d) storing the license in the sink.

FIG. 13B schematically shows the process for storing a license in a secure container according to this second embodiment of the invention. The session manager 502 receives an encrypted license, and executes a process 2402 for saving the license. The license is stored to memory 504 through license management engine 506 and memory management unit 503; The process 2402 for saving the license is composed of decryption 2403 and encryption 2404.

The encrypted license 2401 sent from the source 510 is input to session manager 502. The session key generator 910 generates a session key based on the session with the source 510, and the encrypted license is decrypted using this session key. The decrypted content also contains usage rules, and these usage rules are applied. If necessary, the decrypted license is then re-encrypted. The device-dependent key from the device-dependent key memory 601 is used for re-encryption. The decrypted or re-encrypted license is stored in license pool (NOT SHOWN).

FIG. 14 is a flow chart showing an example of a process for storing licenses in a secure container according to this second embodiment of the invention. The session manager 502 first receives an encrypted license from the source 510 through I/O port 501, and starts the process. The received license could be decryptable using the user's secret key (a unique ID) sent from the source 510 by a different route (such as the mail), or decryptable using a device-dependent key (anonymous).

The license management engine 506 determines if the received license is uniquely identifiable, i.e., has a unique ID (2501). If the license is uniquely identifiable (2501 returns “unique ID”), the encryption engine 507 decodes the license using the secret key of the user having the corresponding ID (2502). If the license is anonymous (2501 returns “anonymous”), the encryption engine 507 decodes the license using a device-dependent secret key (device-dependent key 601) (2503). The license management engine 506 determines if the decoded license is valid or not (2504), and processing ends if the license is invalid (2504 returns no).

The license management engine 506 sends the decoded license to the usage rules administrator 505. The usage rules administrator 505 determines the usage rules based on the received license, applies these usage rules, and determines whether license encryption is necessary (2505).

If license encryption is needed (2505 returns yes), the encryption engine 507 encrypts the decoded license using the device-dependent secret key (device-dependent key 601) (2506). If encryption is unnecessary (2505 returns no), encryption is not applied. The license management engine 506 stores the decrypted license or the re-encrypted license to memory 504 (license pool) (2507).

A unique ID license is a license that is encrypted with a user's secret key, and is stored in the license pool (license management engine). A user's secret key contains information related to the user, such as a password, and is registered as information belonging to the system user. However, a user's secret key that is used for encryption is not public, and even the user is unable to retain a copy other than the key that is stored in the system. This secret key is supplied by the content provider, system manufacturer, or a trusted third party, or generated internally by the device.

Public key encryption in which the key used for encryption and the key used for decryption differ could also be used. If a public key is used, the public key used for encryption is provided by the device. However, a decryption key related to the encryption key cannot be calculated at any desired time using only the encryption key.

To save a license in a secure container, the license data is thus sent from the source to the sink over a secure data channel, and stored in memory in the sink. The license data is never revealed as plain text.

Furthermore, by using the Diffie-Hellman key agreement protocol to open a secure connection between the secure container and sink, a secure connection can be opened using a common, open source method.

Furthermore, the secure connection between the secure container and sink can also be opened using CPRM. Using CPRM enables using this system in all CPRM-compatible environments, including SD cards.

Another method for saving a license has the steps of (a) mutual authentication by the source and sink, (b) sending public key related to the sink to the source, (c) sending a license encrypted using a public key related to the sink from the source to the sink, and (d) the sink decrypting the license using a secret key related to the sink. In this case a public key related to the device is sent to the source when mutual authentication by the secure container and source is successful. The source encrypts the license data using the received public key, and sends the encrypted data to the secure container. The secure container then stores the received data in internal memory.

The embodiments described above can also be used in combination.

To save a license in a secure container, license data is thus sent securely from the source to the sink and saved safely to memory in the sink. The license data is never exposed as plain text.

(Advantageous Effect of the Invention)

It is therefore possible by means of the present invention to freely play legally acquired content without being limited to using dedicated playback hardware or compatible PC hardware having a unique ID, and assure the safe management of license data by providing an encryption algorithm and protocol of securely storing and transmitting digital license data.

Furthermore, a key unique to the system can be used for content encryption, thereby strengthen protection against data theft and tampering. In addition, the system manufacturer or a trusted third party can recognize tampering with or abuse of the secure container or digital license data stored therein.

Furthermore, the present invention can be used for all types of media distribution, both on-line and off-line, and is not limited to any particular platform or media type. In addition to digital content and media rights protection, the invention can also be applied to software, programming distribution, and other license-based protection schemes.

### INDUSTRIAL APPLICABILITY

The present invention can be used in a data protection management device and data protection management method.

1. A data protection management system enabling data communication of a license and encrypted content between a sender and a receiver while protecting and managing the communicated data, the data protection management system comprising:
a session manager for executing a process for acquiring a license and encrypted content from a sender;
a license management engine for storing and managing the license acquired by the session manager; and
memory for storing the license;
wherein when a challenge, which is a request for proof of a license, is received, the session manager generates a certificate verifying the license and sends the generated certificate to the receiver.

2. A data protection management system as described in claim 1, further comprising a usage rules administrator for determining usage rules related to the license, and applying the usage rules to processing at least one of the license and content.

3. A data protection management system as described in claim 1, wherein the session manager encrypts the certificate.

4. A data protection management system as described in claim 1, wherein the session manager adds an optional item from the license to the certificate.

5. A data protection management system as described in claim 4, wherein the optional item data is encrypted using a key contained in the license.

6. A data protection management system as described in claim 2, wherein the usage rules include information for determining, based on the license, data to be added to the certificate.

7. A data protection management system as described in claim 1, wherein the session manager, when a license change is received from the sender, reads the license before the change from the license management engine, changes the license, and saves the changed license in the license management engine.

8. A data protection management system as described in claim 1, wherein the session manager uses the key to decrypt content.

9. A data protection management system as described in claim 1, wherein session manager re-encrypts the decrypted content.

10. A data protection management system as described in claim 9, wherein the key used for re-encryption is generated based on information from the sender.

11. A data protection management method enabling data communication of a license and encrypted content between a sender and a receiver while protecting and managing the communicated data, the data protection management method comprising:
a session step for executing a process for acquiring a license and encrypted content from a sender;
a step for storing and managing the license acquired by the session manager [sic];
a step for storing a key required for decrypting the encrypted content; and
a step for storing the license;
wherein when a challenge, which is a request for proof of a license, is received, the session step generates a certificate verifying the license and sends the generated certificate to the receiver.

12. A data protection management method as described in claim 11, further comprising a step for determining usage rules related to the license, and a step for applying the usage rules to processing at least one of the license and content.

13. A data protection management method as described in claim 11, wherein said session step encrypts the certificate.

14. A data protection management method as described in claim 11, wherein said session step adds an optional item from the license to the certificate.

15. A data protection management method as described in claim 14, wherein the optional item data is encrypted using a key contained in the license.

16. A data protection management method as described in claim 12, wherein the usage rules includes information for determining, based on the license, data to be added to the certificate.

17. A data protection management method as described in claim 11, wherein the session step comprises, when a license change is received from the sender, reading the license before the change from the license management engine, changing the license, and saving the changed license in the license management engine part.

18. A data protection management method as described in claim 11, wherein the session step uses the key to decrypt content.

19. A data protection management method as described in claim 18, wherein the session step re-encrypts the decrypted content.

20. A data protection management method as described in claim 19, further comprising the step for generating the key used for re-encryption based on information from the sender.
